(19) United States
(12) Patent Application Publication
(10) Pub. No.: US 2008/0052363 A1
(43) Pub. Date: Feb. 28, 2008

(54) SYSTEMS AND METHODS FOR INTEROPERABLE MESSAGE SERVICE WITH MOBILE SUPPORT IN A MOBILE COMMUNITY PLATFORM

(75) Inventor: Michael Pousti, San Diego, CA (US)

Correspondence Address: BAKER & MCKENZIE LLP;PATENT DEPARTMENT, 2001 ROSS AVENUE, SUITE 2300, DALLAS, TX, 75201, US

(73) Assignee: SMS.AC, San Diego, CA (US)

(21) Appl. No.: 11/692,125

(22) Filed: Mar. 27, 2007

Related U.S. Application Data
(63) Continuation-in-part of application No. 11/688,584, filed on Mar. 20, 2007.
Application No. 11/688,584 is a continuation-in-part of application No. 11/516,921, filed on Sep. 6, 2006.
(60) Provisional application No. 60/786,553, filed on Mar. 27, 2006.

(51) Int. Cl. G06F 15/16

(52) U.S. Cl. 709/206

(57) ABSTRACT

Methods and systems for an interoperable message service allow users of a community-based platform to send an instant message to another user through any one of multiple message service platforms, and to allow the user to access and utilize the interoperable message service from a standard networked computer, or from a connected mobile device, such as a mobile phone. In this manner, a user can send, receive and reply to instant messages with other users through any one of multiple message service platforms, such as AOL, MSN and Yahoo, from either a standard networked computer or from a mobile device.

### RELATED APPLICATIONS INFORMATION

This Application claims the benefit under 35 U.S.C. 119(e) to U.S. Provisional Patent Application Ser. No. 60/786,553, filed Mar. 27, 2006, entitled “Interoperable Message Service With Mobile Support.” This Application also claims the benefit as a Continuation-In-Part (CIP) under 35 U.S.C. §120 to U.S. patent application Ser. No. 11/688,584, filed on Mar. 20, 2007, entitled “Application Pod Integration With Automated Mobile Phone Billing and Distribution Platform,” which in turn claims priority as a CIP to U.S. patent application Ser. No. 11/516,921, filed Sep. 6, 2006, entitled “Automated Billing and Distribution Platform for Application Providers.” Both of the above applications are incorporated herein for all purposes.

This Application is also related to commonly-owned U.S. patent application Ser. No. 11/446,973, filed Jun. 6, 2006, entitled “Billing Systems and Methods For Micro-Transactions,” and U.S. patent application Ser. No. 11/688,714, filed Mar. 20, 2007, and entitled “Systems and Methods for Generation, Registration and Mobile Phone Billing of a Music Pod System,” both of which are incorporated by reference herein for all purposes.

### BACKGROUND INFORMATION

1. Field

The embodiments described herein relate to a method and system for a messaging service for users of a community platform. The messaging service is interoperable across multiple messaging platforms and also automatically supports mobile devices.

2. Background

While credit card use and automatic credit card billing is a common way to conduct business transactions in many countries, they are not necessarily the best way in some situations. In particular, there are many users of the internet that do not have access to a credit card. However, these users most likely have cellular telephone service. Also, use of a credit card is economically viable only if the transaction amount exceeds a particular amount that depends on the underlying efficiency of the billing and collecting system.

Currently, cellular telephone carriers (or mobile phone carriers, the terms are used interchangeably throughout this specification) routinely bill users for small transactional amounts and are able to do so while making a profit. These transactions are referred to as micro-transactions and, in terms of U.S. currency, can be as small as a few pennies (additionally, larger transactions occur as well). Retailers or vendors may desire to provide their respective content or services to mobile phone users via the web or directly through the user's mobile phone, and bill for such content or services as micro-transactions. Currently, a retailer or vendor will find it very difficult to take advantage of this opportunity for micro-transaction billing for their content or services accessed by a mobile phone user because doing so would require the retailer/vendor to personally negotiate and reach a contractual agreement with the particular cellular carrier to which the mobile phone user is subscribed. The process is further complicated by the fact that not all consumers use the same cellular carrier and, therefore, the retailer/vendor would need to contract with hundreds of different cellular carriers around the globe to be able to have this billing option available to the desired global market of mobile phone users.

Thus, there exists a need for a system and method that allows retailers to easily conduct transactions, many of which may be micro-transactions, with the global market of mobile phone users, where the transactions are easily billable to a wide variety of cellular carriers while eliminating the need for each retailer/vendor to individually contract with each of the wide variety of cellular carriers. In addition, it is desirable to provide a support system for retailers to develop application pods that are a dynamic and community-based for access and use by mobile phone users.

Additionally, conventional message services, known as instant messaging, are provided that allow a user of the message service to quickly send a text message to another user of the message service. Some of these message services are provided by AOL, MSN and Yahoo, among other providers.

These services typically require the user to be a subscriber/member of the particular message service in order to send an instant message to another subscriber/member of the same message service. In this regard, a “sender” user can be restricted from sending an instant message to a “recipient” user of another message service platform to which the “sender” user does not subscribe.

The growing use of connected mobile devices, such as mobile phones, PDAs and other mobile devices has generated the need for accessing and utilizing an instant message service from such mobile devices.

Accordingly, it is desirable to have an interoperable message service which allows a user to send an instant message to a user through any one of multiple message service platforms, and to allow the user to access and utilize the interoperable message service from a standard networked computer, or from a connected mobile device, such as a mobile phone.

### SUMMARY

Methods and systems for an interoperable message service allow users of a community-based platform to send an instant message to another user through any one of multiple message service platforms, and to allow the user to access and utilize the interoperable message service from a standard networked computer, or from a connected mobile device, such as a mobile phone.

In one aspect, the interoperable message service detects whether the user is accessing the message service from a standard networked computer or from a connected mobile device and, if the user is connected through a connected mobile device, the message service forwards instant messages to the user's mobile device through SMS messages via the user's mobile phone carrier.

In this manner, a user can send, receive and reply to instant messages with other users through any one of multiple message service platforms, such as AOL, MSN and Yahoo, from either a standard networked computer or from a mobile device.

These and other features, aspects, and embodiments of the invention are described below in the section entitled “Detailed Description.”

### BRIEF DESCRIPTION OF THE DRAWINGS

Features, aspects, and embodiments of the inventions are described in conjunction with the attached drawings, in which:

FIG. 1 is a block diagram that illustrates an exemplary computer system that can be configured to implement the systems and methods described herein;

FIG. 2 is a block diagram that illustrated a computer-based mobile community in accordance with one embodiment;

FIG. 3 is a block diagram that illustrates a more detailed view of the high-level system view of FIG. 2;

FIG. 4 is a flowchart illustrating an example method for distributing software via the mobile community architecture of FIG. 2;

FIGS. 5-8 are screenshots illustrating example windows that software developers may be presented to assist in registering a new pod with the mobile community architecture of FIG. 2;

FIG. 9 is a diagram illustrating an example pod that can be developed and registered using the process depicted in screenshots 5-8;

FIG. 10 is a diagram illustrating an example user profile page that can include pods, such as the pod of FIG. 9, and can be hosted by the mobile community architecture of FIG. 2;

FIG. 11 is a flowchart illustrating an example method for a user to add a pod to their profile page;

FIGS. 12 and 13 are flowcharts illustrating the operation of a pod and its associated pod application within the mobile community of FIG. 2;

FIG. 14 is a block diagram of a global mobile platform that can be included in the computer-based global mobile community of FIG. 3;

FIG. 15 is a flow chart illustrating an example method for instituting a complaint department within the mobile community of FIG. 2;

FIG. 16 is a flowchart illustrating an example method for regulating messages within the mobile community of FIG. 2;

FIG. 17 is a block diagram illustrating another example embodiment of the global mobile platform of FIG. 3;

FIG. 18 is a diagram illustrating an example pod that includes content and content tags according to one embodiment;

FIG. 19 is a block diagram of a computer-based mobile community platform according to another embodiment;

FIG. 20 is a block diagram of in interoperable instant message service according to one embodiment; and

FIG. 21 is a flowchart for explaining the interoperable instant message service of FIG. 20 according to one embodiment.

### DETAILED DESCRIPTION

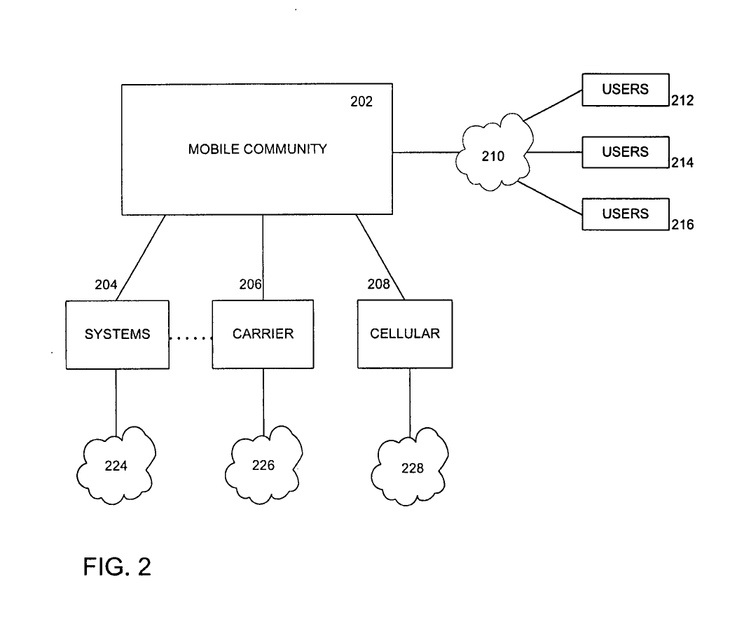

FIG. 2 depicts a block diagram of a computer-based mobile community 202. Users 212, 214, 216 can connect to the mobile community 202 via a network or similar communications channel 210. Via the connection, a user (e.g., 212) may create a profile page or “home page” that they can personalize. This profile page can include various files and content that the user wants to share with other members of the mobile community 202.

The profile page may include a hierarchy of pages, some of which are for public view and some of which have restrictions on viewing. For example, the mobile community 202 can be logically organized into neighborhoods such as “friends”, “family”, “workplace”, “dog owners”, etc. Users 212, 214, 216 can belong to these different neighborhoods and share different pages with the members of the different neighborhoods.

Additionally, this mobile community 202 connects with various cellular carrier systems 204, 206, 208, each of which has an associated community of mobile phone subscribers, 224, 226 and 228. Users 212, 214, 216 of the mobile community 202 are also subscribers of various cellular carriers. In this way, users 212, 214, 216 of the mobile community 202 not only have access through the computer-based platform 202 to other users' profile pages, they also have easy access to subscribers of the various cellular carrier systems 204, 206, 208.

A benefit of the architecture depicted in FIG. 2, is that the mobile community platform 202 has already contracted for services with the cellular carrier systems 204, 206, 208. As is known in the art, the cellular carrier systems 204, 206, 208 provide messaging and premium message functionality. Such messages are sent via the cellular carrier's infrastructure to mobile subscribers and, internal to the cellular carrier's infrastructure, generates a billing event according to a particular tariff rate. In practice, when the mobile community 202 sends a message via a cellular carrier system (e.g., 204), it is billing the recipient of the message using the existing billing system of that cellular carrier. The billing event is often a micro-transaction. Thus, a user (e.g., 212) of the mobile community may conduct transactions with a vendor within the mobile community 202 and be billed for those transactions via their cellular service account. The vendor in the transaction need only communicate with the mobile community 202 regarding the transaction and does not require any affiliation or agreement with any cellular carrier.

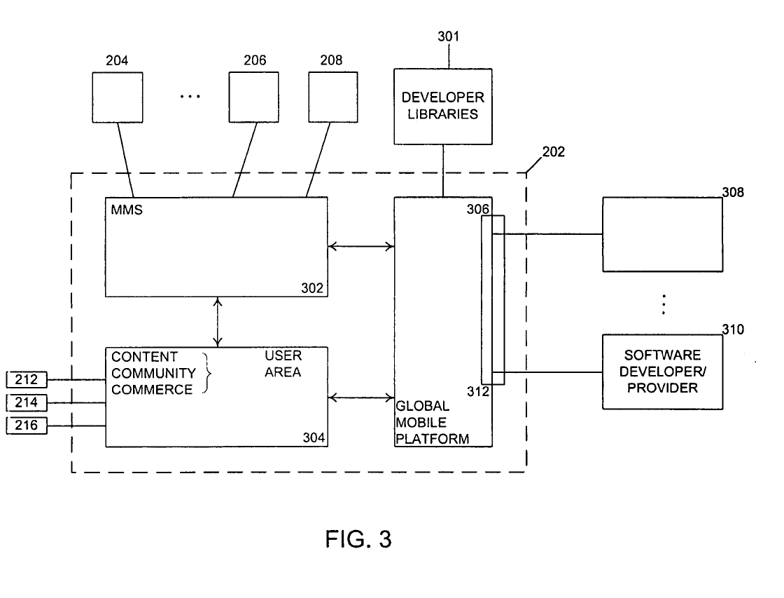

FIG. 3 depicts a more detailed view of the high-level system view of FIG. 2. In particular, the system of FIG. 3 can be used to conduct micro-transaction in which a cellular carrier's billing system is used by the mobile community 202 platform to automatically bill the user for each micro-transaction with a vendor/retailer, without the need for a negotiation or contract between the vendor and the cellular carrier. One example of this feature is that of software content distribution where software developers can offer software products to the users of the mobile community 202, while taking advantage of the billing arrangements already in place between the mobile community 202 and the cellular carriers 204, 206, 208. Of course, a software application may provide any other type of content or service to users of mobile community 202.

Some of the sub-components of the mobile community 202 are a global mobile platform 306, the user area 304 where the content, community and commerce functions are handled for the users, and a multimedia messaging system 302. The details of these different sub-components are more fully explained throughout the remainder of this detailed description.

As noted earlier, users 212, 214, 216 can visit the user area 304 to participate in an on-line community that includes various content and commerce opportunities. This is typically accomplished via a user's web browser that may be hosted on a laptop or desktop computer, or, in the alternative, even on the user's mobile device such as a PDA or mobile phone. Thus, the user area 304 includes a web server that communicates with users 212, 214, 216 and includes a data store of user information and other content. With these resources, the mobile community 202 is able to present to a user 212 a profile page (“home page”) that reflects content and information associated with, and desired by, that particular user. This content and information is not maintained on the local computer being used by the user 212 but, rather, is maintained and managed by the computer systems within the user area 304.

Although not explicitly depicted in FIG. 3, one of ordinary skill will recognize that there are numerous functionally equivalent techniques to create, manage, store and serve user information, user profiles, user content, software tools and other resources within the user area 304. Included in these techniques are methods to ensure security, data integrity, data availability and quality of service metrics.

The multimedia messaging system 302 includes applications for connecting with and communicating with the multiple different cellular carriers 204, 206, 208 that have been partnered with the platform of mobile community 202. The MMS 302 is configured to generate message requests in the appropriate format for each of the cellular carriers 204, 206, 208 including tariff information that determines the amount for which the recipient of the message will be charged. Upon receipt of the message request, the cellular carriers 204, 206, 208 will use the information in the request to generate an appropriate message to the intended recipient/subscriber of the cellular carrier and then bill the recipient/subscriber's cellular service account for the specified amount.

The MMS 302 communicates with the user area 304, such that users of the mobile community 202 can advantageously use the connectivity of the MMS 302 with the carriers in order to send messages to subscribers of any of the cellular carriers 204, 206, 208. The messages may be SMS messages, MMS messages, or other message formats that are subsequently developed. Some of these messages may have zero tariff and, therefore do not generate a bill (other than the underlying charges implemented by the cellular carrier) and others may have non-zero tariffs resulting in a billing event for the recipient.

The global mobile platform 306 provides a link between software developers/providers 308, 310 and the mobile community 202. In particular, using an interface 312 (described in more detail herein), a software provider 308, 310 may offer services and products to users 212, 214, 216. Advantageously for the software provider 308, 310, the global mobile platform 306 also provides automatic and instant connectivity to the MMS 302 and the cellular carriers 204, 206, 208. Accordingly, the software provider 308, 310 can interact with all users of the mobile community 202 whereby billable transactions with users 212, 214, 216 are automatically billed via the billing systems of the cellular carriers 204, 206, 208. Furthermore, and importantly, this capability is available to the software provider 308, 310 without requiring the software provider 308, 310 to negotiate or contract with any cellular carrier for billing arrangements, or to worry about how to communicate with a cellular carrier's systems and resources. The software provider seamlessly takes advantage of the unified set of connectivity and billing arrangements that exist between the mobile community 202 and the cellular carriers 204, 206, 208. Thus, in addition to the contractual arrangements and affiliations the mobile community 202 has in place with different carriers 204, 206, 208, the underlying technical and communications infrastructure is also in place to communicate with and interoperate with each of the different carriers 204, 206, 208. As a result, vendors and other members of the mobile community may interface with and operate with any of a variety of different carriers without difficulty.

While some software applications that are available to users 212, 214, 216 may be hosted in the user area 304, the global mobile platform 306, or elsewhere in the community 202, it is often the case that the software developer/provider 308, 310 will host their own software application at their own remote location. Accordingly, in the description that follows, even if remotely-hosted software is being discussed in a specific example, one of ordinary skill will readily appreciate that software application being hosted differently is also expressly contemplated.

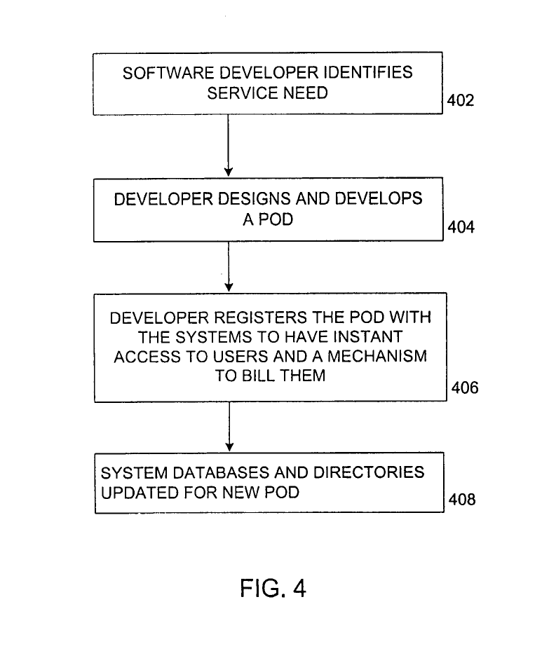

FIG. 4 depicts a flowchart of an exemplary method for distributing software via the mobile community architecture of FIG. 2. In a first step 402, a software developer identifies a marketplace need that is not being fulfilled. In other words, the software developer believes that there is a service or product that they can provide that will be profitable. The variety of different types of services, content and products that can be offered to users via a software application is limited only by the imagination of the different software developers.

The term “pod service” or “pod application” is used in the following description as a label for software applications offered through the mobile community 202. This label is used merely for convenience and is not intend to limit or restrict the types, variety and capabilities of potential software applications in any way. As used herein, the term “pod” refers both to the underlying information related to the pod application and to the graphical rendering of the pod application on a user's profile page within the mobile community 202.

Once the marketplace is identified, the developer commences development of their software application in step 404. The underlying application logic is up to the developer and can utilize any of the widely known programming environments and techniques available to one of ordinary skill in this area. However, the software application will be offered within the mobile community 202 along with a variety of other software applications. Accordingly, standardizing the look and feel of the application and information about the application will aid the users 212, 214, 216 and make their community experience more enjoyable.

Once a pod application has been developed (and most likely tested and verified) by a developer, the developer registers, in step 406, the pod application with the global mobile platform. Registering the pod application, which is described in more detail later with reference to a number of screenshots, allows the software developer to inform the global mobile platform 306 that a new pod application is available for the access by mobile community 202.

Once a pod application is registered, the global mobile platform 306 updates, in step 408, system databases and directories for the new pod application and its associated information. In the above description of FIG. 4, it is evident that the pod developer communicates with the mobile community 202 for a number of different reasons. One of ordinary skill will recognize that these various communications between the pod developer and the mobile community can occur via any of a variety of functionally equivalent means. For example, both wired and wireless communication methods for these communications are explicitly contemplated.

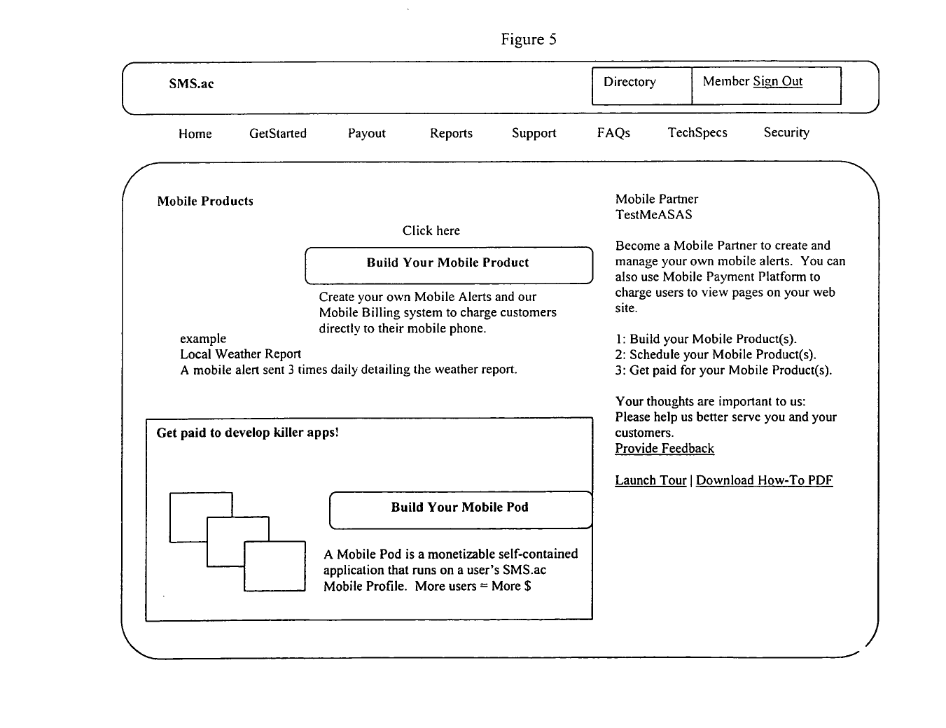

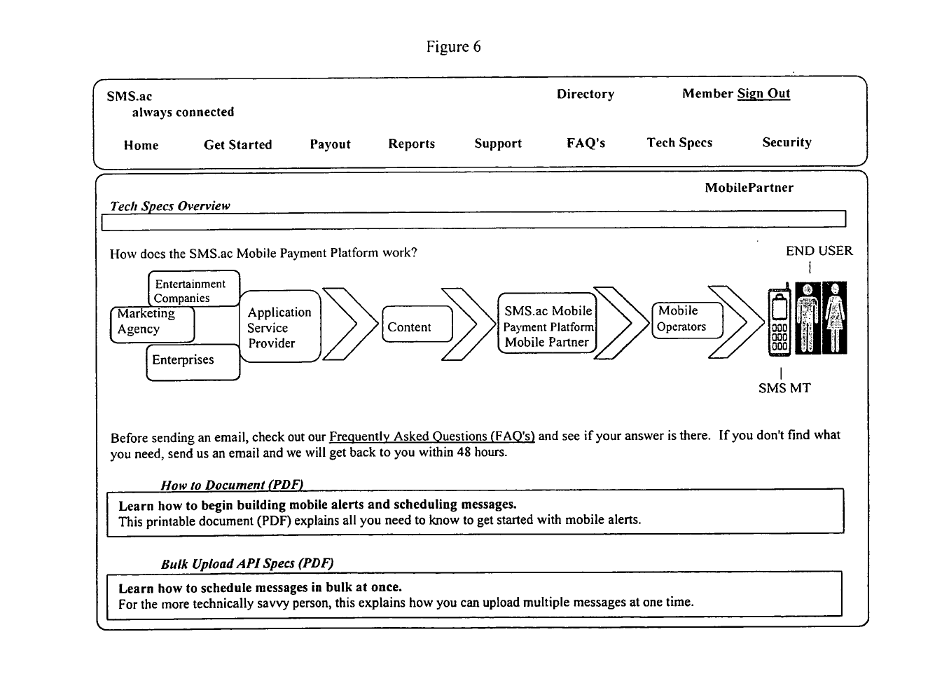

FIG. 5 is a screenshot of an exemplary window that software developers may be presented to assist in registering a new pod. From this screen, the software developer can navigate to a screen that provides more technical information such as the one shown in FIG. 6. This screen illustrates to the developer how the pod application takes advantage of the existing mobile payment platform when used by an end user.

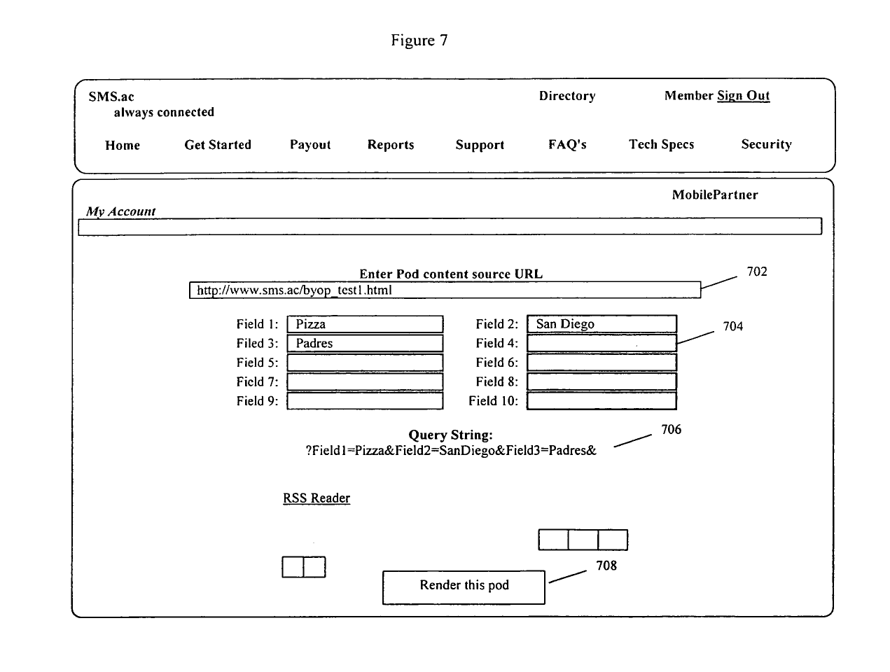

FIG. 7 is a screenshot of an exemplary pod registration screen. Because the pod application is most likely hosted remotely, an input window 702 allows the pod developer to provide the URL of where the pod application is located. When a user ultimately uses the pod within the community 202, this URL is the location from where the content for the pod application is retrieved. For example, if the pod application was developed to display pictures for a dating service, this URL would point to code that when executed could detect user input events and result in the display of appropriate images.

The pod developer can utilize the field input boxes 704 to specify different fields that can capture input when a user first accesses a pod. For example, if a pod application is developed to provide stock quotes, then these fields could be defined to accept stock symbols. When the user views the pod within their profile page, these fields can be filled in with appropriate stock symbols, for example. When the user then selects a “submit” button, this information is sent to the pod application which returns the appropriate information.

As is well known to HTML and HTTP developers, based on the information that is filled in the field windows 704, a particular query string will be appended to a request received from a user's form submission. To aid a developer in registering a pod, this query string is automatically generated and displayed for the pod developer in region 706 of the exemplary screen. To give the pod developer a quick view of how the pod will be rendered, a button 708 is provided to illustrate the pod. With this information, the developer may choose to revise their design.

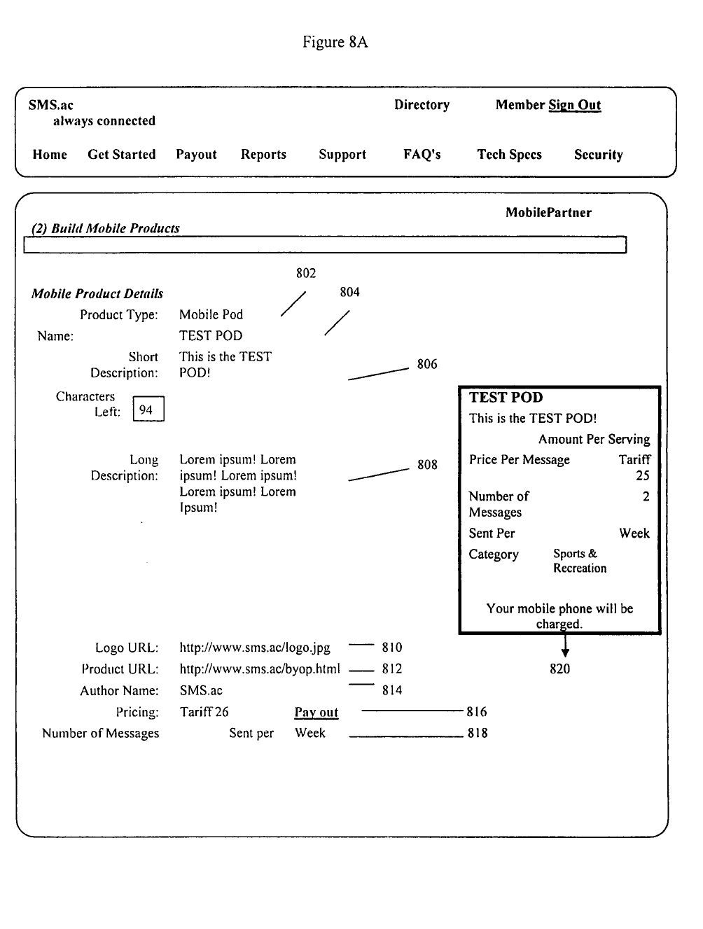

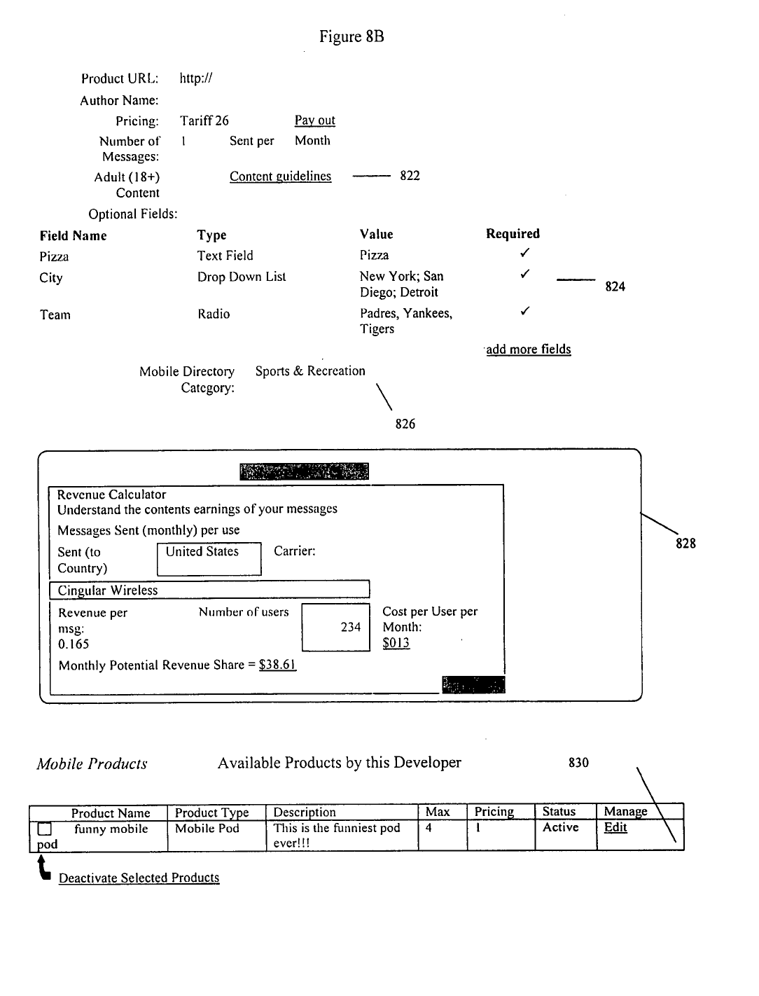

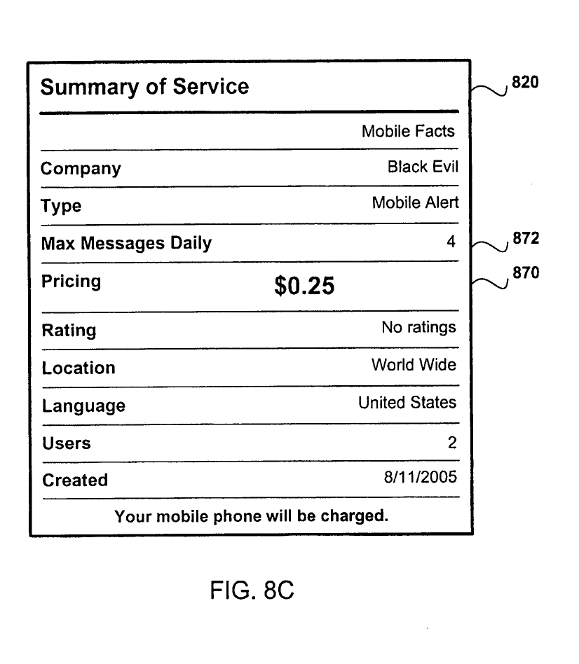

Once this initial information is collected, the global mobile platform 306 collects additional information that is associated with the pod. In FIGS. 8A and 8B, a number of input fields 802-830 are provided for the pod developer to fill in while registering their pod application. Many of these fields are self-explanatory; however, some warrant a more detailed discussion. In particular, a pricing window 816 is available for the developer to select an appropriate pricing scheme, according to a standardized pricing structure. According to one embodiment, pricing occurs in fixed tariff bands. For example, one band would be a $0.25 band and would be used for products or services that the developer thinks users would purchase for around $0.25. Another band may be $1.00 and would be for higher priced items and still other bands can be used as well. According to this arrangement, not all prices are available to the developer; instead, the developer picks the closest band to use (e.g., the $1.00 band is selected even if market research shows users would actually pay $1.03 for the service).

Additionally, the pod application will likely be used by people in different countries. Because of the vagaries of global economics, $0.25 may be too high of a price-point in many countries. Thus, it is more appropriate to set a price-point for each separate country from which the pod application may be used. While it is possible for the global mobile platform 306 to permit the pod developer to set such a vast number of price-points, most developers will not have the knowledge or the patience to perform such a task. Accordingly, the global mobile platform 306 automatically provides a price band selection for each country based on their respective costs of living. In other words, a developer can select a price band in the currency that he is comfortable with and let the global mobile platform 306 translate that to an equivalent price band in each country.

Via the input field 818, the developer also specifies the number of messages and frequency that their pod application will send to each user. Based on their knowledge of having developed the pod application to perform a particular service, the pod developer may, for example, know that no more than 4 messages per day (per user) will be sent from their pod application. This information sets the terms and conditions for billing the user. Thus, they would fill in this field 818 accordingly. As explained later, the global mobile platform 306 can use this information to control message traffic within the community 202.

The benefit of specifying the pricing information and number of message information is that the terms and conditions of the pod application can be provided to a user in a uniform manner. Window 820 displays, for the pod developer, how the pod application information, including pricing, terms and conditions, will be shown to a user. FIG. 8C depicts a more detailed view of this uniform pricing display. Much, like nutritional labels on food products provide a uniform format for presenting the nutritional information, the format depicted in window 820 can be used to uniformly present information about pod applications. Thus, a user of the community does not have to learn and interpret different pricing information for each different pod developer. Instead, the uniform format 820 simplifies understanding this information. The exemplary format of window 820 includes a variety of information about the pod application. Of particular interest to most users is the uniform manner in which the pricing information 870 and the message information 872 is clearly presented. One of ordinary skill will appreciate that the format of window 820 is merely exemplary in nature and can vary in numerous ways without departing from the intended scope. Accordingly, the exemplary format of window 820 is provided to illustrate that the global mobile platform 306 is arranged so as to provide users of the community 202 with uniformly formatted information from a variety of different pod applications so as to simplify the evaluation and comparison of different offerings. With such a uniform pricing arrangement being utilized, it becomes possible to monitor the behavior of pod developers with respect to their specified pricing structure and implement control measures such as limiting or restricting their activities within the mobile community if warranted.

Once the information of screens 8A and 8B are submitted to the global mobile platform 306, the pod application is registered with the mobile community 202. According to at least one embodiment, the pod application is evaluated by a moderator of the mobile community 202 to ensure it is acceptable from a technical and content point of view for the community 202. In this scenario, the pod application is not registered until the evaluation is completed satisfactorily.

Information about a registered pod application is stored within the global mobile platform 306 in such a way that when a user wants to include a pod on their profile page, the pod can be rendered using the stored information and interaction between the pod and user will occur based on the stored information as well. In such a case, the data associated with the user will be updated to reflect that the user is now accessing and using the pod.

Thus, according to the previously described technique, a pod developer can automatically register a new pod application (even from a remote location) without difficulty in such a way that the pod automatically becomes available to users of the mobile community 202 at the conclusion of the registration process. Furthermore, from the pod developer's point of view, the pod application may immediately take advantage of the billing platform used by the mobile community 202 without the need to have existing contracts in place with one or more cellular carriers.

One benefit of registering pod applications in this manner is that once registered, the global mobile manager 306 can prevent the terms and condition information from being changed by the pod developer. Thus, a user's agreed upon price and operating parameters will not be modified (with or without their knowledge).

The users of the global community can locate available pod applications in a number of different ways. First, the community 202 facilitates sharing of information by people having common tastes. Accordingly, within the community users frequently visit other users profile pages looking for interesting content and information, particularly with neighborhoods to which the user belongs. During this visiting of other members' home pages, a user can discover an interesting pod and want to get it for them. In terms of the community, a user “owns” their own profile page and is called an “owner” when at their profile page. In contrast, when a user visits some else's profile page, they are considered a “viewer”. Within the mobile community 202, the profile pages are maintained such that the view by an owner may not always correspond to that seen by a viewer as the owner may want some information to be private and other information to be public.

In another instance, a user may know a friend or colleague would want a particular pod application; thus, the community 202 allows a user to inform another user about the existence of a new pod application. Another way in which pod applications are located is via a directory within the mobile community 202. For example, the global mobile platform 306 registers each pod application as the developers submit them; it is a simple extension to include a database update and a searchable-directory update as part of the registration process (see step 408 of FIG. 4).

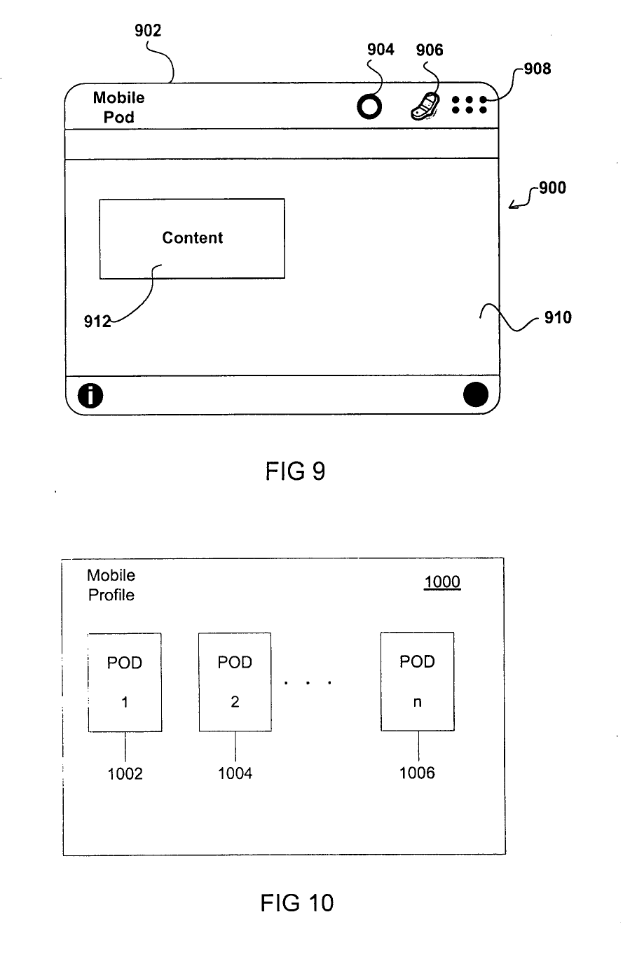

A rendering of an exemplary pod 900 is depicted in FIG. 9. The pod includes a title bar 902 with a number of icons 904-908. The main window 910 of the pod is where the content 912 is displayed. This content is based on the associated pod application and the stored system information associated with this pod. From the pod 900, a user launches an initial message to the associated pod application. In instances where the pod application provides content back to the pod 900, the window 910 is updated. By using remote scripting capability, as is known in the art, the updating of window 910 can occur without the user manually refreshing the window 910. Similar to the profile pages described earlier, the pod 900 can be designed to provide different views of content 912 to a user depending on whether the user is an “owner” or a “viewer”.

The icon 904 can be selected by a user (for example, when viewing someone else's pod) to add that pod to their own profile page. The icon 906 can be selected to inform another user about this pod and a drag icon 908 can be used to move the pod around a user interface screen. The “information” icon 914 is useful for displaying information about the pod, including the uniform pricing information described earlier.

FIG. 10 depicts an exemplary user profile page 1000 that has arranged thereon a plurality of pods 1002, 1004, 1006. In this manner, the pods available to a user can be displayed on their profile page. As noted earlier, the user can access this profile page via a number of different devices. For example, in addition to use of a traditional web browser, a portable device such as a smart phone or PDA can be used to access the profile page and pods. Such portable devices can utilize traditional WAP-based or HTML-based techniques to access the pods but they may also utilize device-based applications with proprietary protocols specifically developed to advantageously utilize the capabilities provided by pods and pod applications. Other example techniques implemented by portable devices that can be configured to access a profile page described herein include BREW, J2ME, etc.

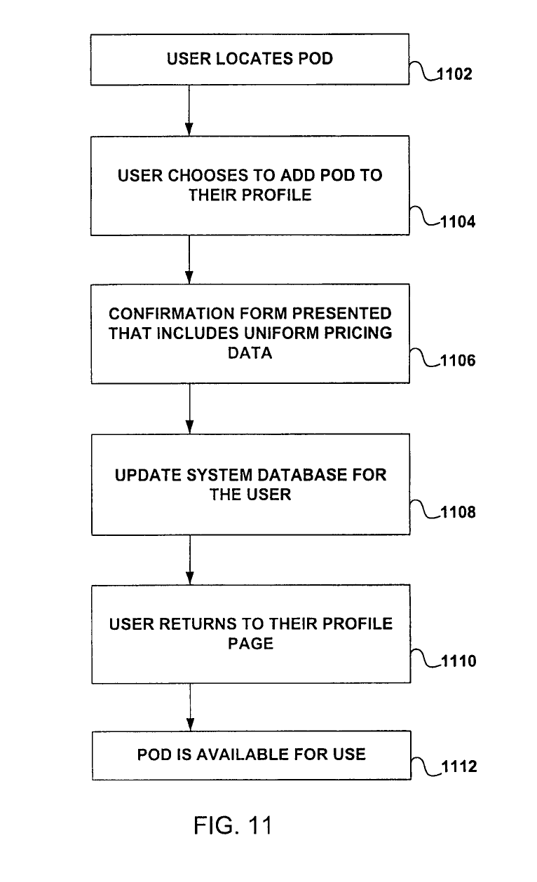

FIG. 11 illustrates a flowchart of an exemplary method for a user to add a pod to their profile page. In step 1102, the pod user locates an interesting pod via a visit to another user's profile page or through a directory search. In evaluating the pod, the user can see the terms and conditions of the pod in the uniform presentation format described earlier. Next, in step 1104, the user chooses to add the pod to their profile page; typically using a standardized feature on the pod. In step 1106, a confirmation page is sent to the user to ensure they know the pricing information about the pod and to ensure they are aware of the likelihood of their cellular service account being billed as a result of executing the pod application. Assuming the user confirms their selection, the user area 304 updates, in step 1108, its data store about this user such that the records indicate the user owns this new pod on their profile page. When the user next visits their profile page, in step 1110, and as a result of the user area 304 rendering their profile page on their browser, the new pod will be displayed. With the pod displayed within the profile page, it is now available for use by the user, in step 1112.

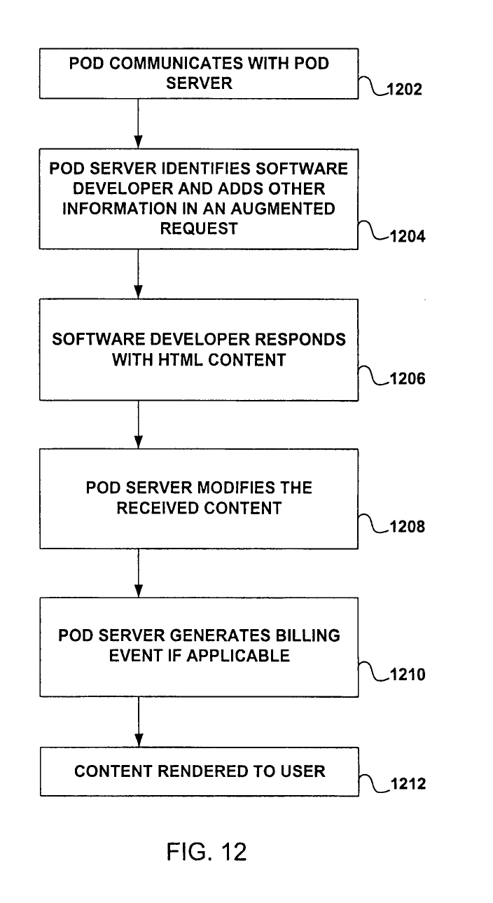

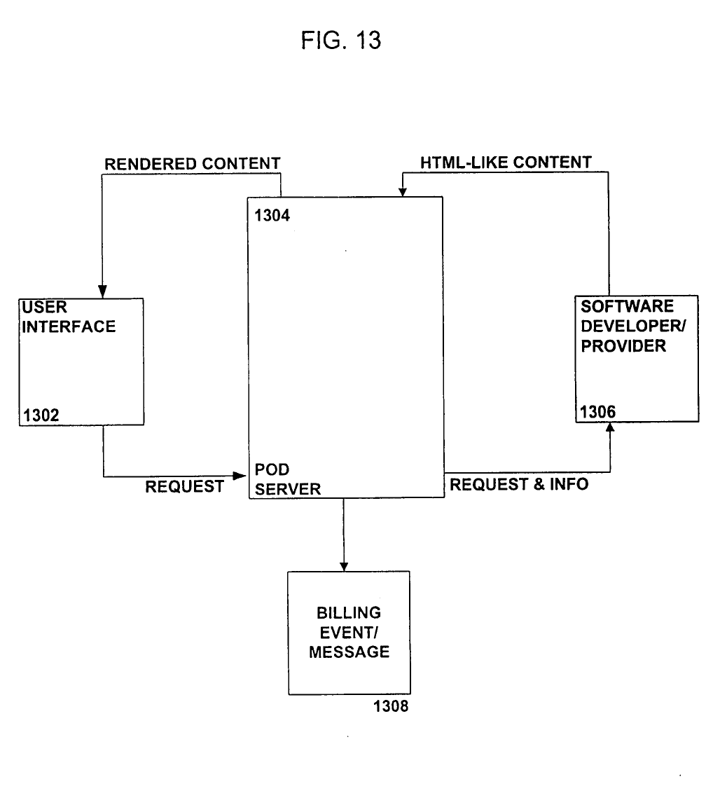

FIGS. 12 and 13 illustrate the operation of a pod and its associated pod application within the mobile community 202. As known to one of ordinary skill, the pod server 1304 may be a process executing on a separate, dedicated processor or may be included as part of the user area 304 or the global mobile platform 306. In step 1202, a user interacts with some feature on the pod user interface 1302 to generate a request. This request includes the URL associated with the content of the pod and a query string (if any) based on the fields of the pod, and information input by the user. The query string is sometimes referred to as transient parameters.

In response to the request from the pod user interface, 1302, the pod server 1304 identifies the pod developer and the URL of the content and adds some additional information, in step 1204. The augmented request is sent to the software provider's application 1306 which responds, in step 1204, to the augmented request.

The information added to the augmented can request include demographic information about the owner and viewer of the pod. In this way, the software application 1306 can respond with a first type of content if the owner and viewer are the same or respond with different content if the owner and viewer are different. One way to accomplish this distinction is for the user area 304 to refer to users by a unique user ID number. Thus, users can be distinguished without revealing sensitive information to a software developer such as the mobile telephone number of a user. Also, the software application 1306 can use this demographic information to collect statistics about its users.

Other additional information that might be added would include details about the type of user interface the user has available. Because users may be using their mobile device, their display may not be as robust as a desktop interface. Thus, a software application 1306 can control content based on the current graphical and bandwidth capabilities of the user. For example, the additional information can indicate whether the user is operating in a web-based or mobile-based environment, e.g., a WAP, BREW, J2ME, etc., based environment.

In response to the augmented request, the software application 1306 responds with code, in step 1206, that is substantially HTML data. This code is generated according to the application logic of the pod application 1306. In other words, it is the content that is returned to the user who is viewing the pod. In certain embodiments, the code of the response varies from conventional HTML in certain ways. For example, because this is a managed communication system, non-standard HTML tags can be used and supported. Thus, non-standard tags can be used that are specific to the pod environment and that are not applicable to generic HTML pages. For example, a pod has a title area and a message area. Tags specifically for controlling these areas may be used to add functionality to the pod environment described herein. One of ordinary skill will recognize that a number of different specialized tags and capabilities can be offered without departing from the intended scope.

An additional variation from HTML is that of using templates where information can be provided by the pod server 1304. For example, for privacy concerns, little identifying information is sent to the software application 1306. However, the pod server 1304 has access to this information because it communicates with the user information stored in the user area 304. Thus, the use of templates will allow software applications 1306 to take advantage of this information to personalize the pod experience. For example, the template may include a tag <! FirstName !>. When the pod server 1304 encounters this tag in the template, it knows that the software application 1306 intends for the pod server to insert the first name of the user. A more detailed list of exemplary template tags is provided in the previously mentioned incorporated document.

When the pod server 1304 receives the HTML-like reply from the software application 1306, the pod server manipulates the reply into a format useful for the pod environment. For example, certain HTML features such as, for example, javascript, iframe, frame, and script features, are removed from the reply in order to improve the security of the content. Secondly, the pod server 1304 can replace the personalizable parameters in the templates with the actual user information. And thirdly, the pod server 1304 can translate the content into other display formats, depending on the operating environment of the user (mobile or computer).

For example, if a software provider is well-skilled in providing WAP code as opposed to conventional HTML code, then that provider can control which code, or content, is generated based on the information it knows about the user's interface. However, if a software provider is not skilled with, or does not support, generating content in different formats, then the software application can request (as part of the code it sends back to the pod server 1304) that the pod server 1304 translate the code into a more appropriate format.

Another modification the pod server 1304 can make is that of manipulating the hyperlinks within the code sent by the software provider. Under normal behavior, such a hyperlink would result in opening another browser window and following the link. As is known to one skilled in this area, the original hyperlinks are adjusted by the pod server 1304 so that following of the links remains under the control of the pod server 1304 and the user interface remains within the focus of the pod instead of some other browser window.

Once the pod server 1304 completes its changes to the original code in step 1208, the server 1304 renders the code and content to the user's pod 1302, in step 1212.

In addition to the code that is received from the software application 1306, the pod server 1304 can also receive information from the software application 1306 about a billing event that should be triggered for the particular content that the user requested. For example, the user may have requested a stock quote that will cost $1.00. When the application 1306 generates the content of the reply, it also generates a message that the pod user should be charged $1.00 for this transaction. One of ordinary skill will appreciate that there is wide variety of protocols for the pod server 1304 and the software application 1306 to exchange information related to a billable transaction. During operation, therefore, the software developer's application 1306 merely adheres to the agreed upon protocols to inform the pod server 1304 that a billable transaction has occurred.

When the pod server 1304 determines that the code from the application 1306 includes an indication that billing should occur, the pod server 1304 generates a billing event 1308, in step 1210. This billing event 1308 is forwarded to the global mobile platform 306 so that billing may occur by using the cellular carrier's underlying billing systems. The pod server 1304 has access to the recipient information (i.e., the pod user) and the billing rate of the pod application 1306. Therefore, an appropriately formatted billing message is easily generated.

The global mobile platform 306 includes a message interface 1402 to handle billing events from a variety of sources. Although a different interface could be designed for each different source of billing events, it is more efficient to use a single Application Programming Interface (API).

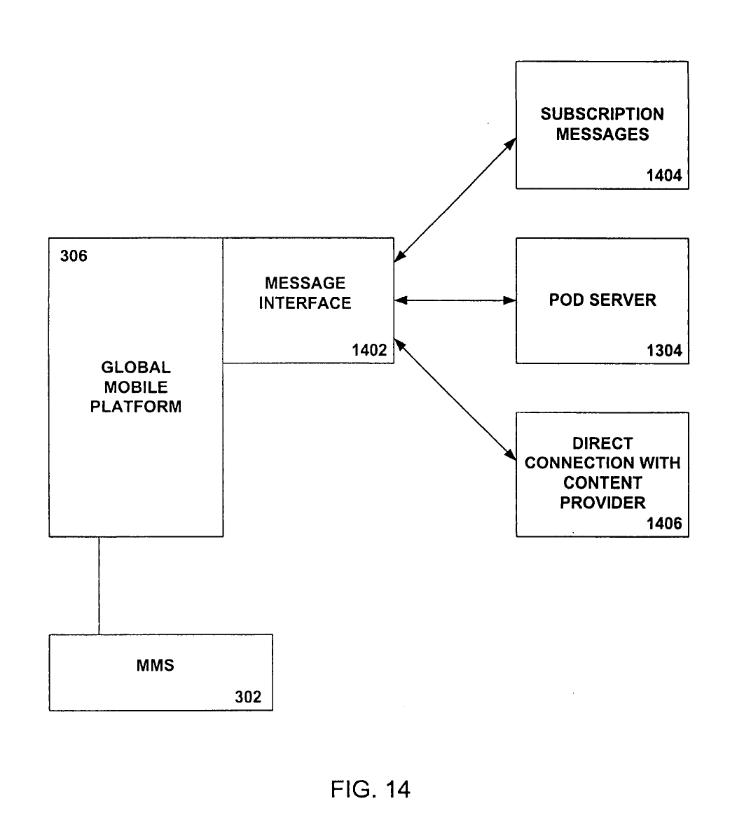

One type of billing message originates from subscription-based services. Under these circumstances, a database or other storage system maintains a record of when to send a message to a user on a predetermined periodic basis (e.g., daily, monthly, weekly, etc.). When the management system for these subscription services indicate that a message is to be sent, then this message is forwarded to the interface 1402 (FIG. 14) of the global mobile platform 306 with the appropriate tariff information included.

As discussed earlier, the pod server 1304 can also generate a message based on a discrete billable event occurring due to the user's operation of a pod application. In this instance the billing message 1308 is forwarded to the interface 1402.

In another circumstance, the pod application may operate so as to avoid sending content back through the pod server 1304 but still be designed to perform a billable event. For example, the pod application may be a virtual greeting card application that sends text messages to people based on whether it is their birthday, anniversary, etc. and charges the pod user $0.25 for each card. Thus, the pod application 1306 performs billable activities but not via the content it sends back through the pod server 1304. Under these event-based circumstances, the software provider can establish a direct connection with the interface 1402 and send a billable message via the established API.

Regardless of how the billable event arrives at the interface 1402, the global mobile platform 306 processes it such that a message is sent via the MMS 302 through the cellular carriers to the user of the pod. This message, the content of which may say, for example, “Thank you for being a valued customer of xxx” will have associated with it a tariff code that results in the user being billed via their cellular service account.

Thus, a business model is established where the cellular carrier bills a user for various events and shares an agreed-upon portion of that billing with the mobile community platform who, in turn, shares an agreed-upon portion of that billing with the software provider. The carrier benefits from additional billable data traffic and the software provider benefits by obtaining instant access to all the users of the mobile community as well as instant access to the cellular carriers' billing systems in a seamless and unified fashion through the platform.

The presence of the global mobile platform 306 between the software provider's application 1306 and the MMS 302 provides the benefit that the messaging of different users of the mobile community 202 can be controlled to ensure the mobile community 202 is more enjoyable.

Within the mobile community, the various computer-based components discussed thus far have a vast amount of information stored and readily accessible. For example some of the information includes: identifying information about each pod application, identifying information about each user, identifying information about which pods are associated with each user, information about the terms and conditions regulating the operations of a pod application, and information about messages being sent via the mobile community 202. With this information available, one of ordinary skill will recognize that a number of operating parameters of the mobile community 202 can be monitored and controlled.

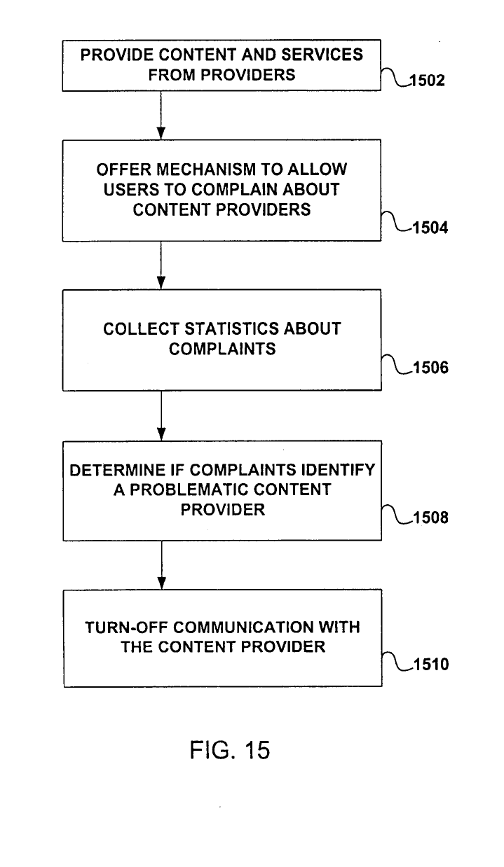

FIG. 15 depicts a flowchart of an exemplary method for instituting a complaint department within the mobile community 202, which can ultimately result in automatic cut-off of access to, and billing activities by, a software application. In accordance with this flowchart, while all the parties are using the mobile community 202, content and services are being provided by different software application providers in step 1502. Within the profile page of a user, or alternatively at a more centrally located page, a link may be provided, in step 1504, to submit a complaint. The global mobile platform 306 then collects these complaints and generates, in step 1506, statistics about them. For example, one statistic may be to identify what percentage of users of a pod application are complaining that it fails to operate as promised, provides unsuitable material, improperly bills, or includes some other problem.

In step 1508, the complaint statistics are evaluated to determine if a problem exists. Typically there would be checks and balances used to ensure that a single user is not abusing the system with a flood of complaints or that 100 complaints is not really a problem if the user base is 10 million. If a problem is found to exist with a particular pod application, then in step 1510, the global mobile platform turns-off communication with this pod application. Thus, the pod server can be informed to ignore any communications to or from that particular application. Because a software provider may supply more than one pod application, it is contemplated that the system could turn-off communication with all applications from that provider, not simply the ones relating to only the problematic application.

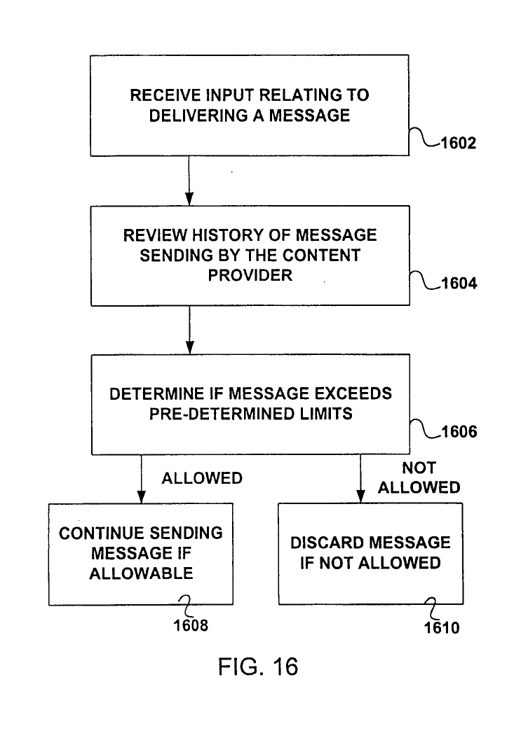

FIG. 16 provides a flowchart of an exemplary method for regulating messages such that the agreed upon terms and conditions of the operating parameters of the pod application are adhered to. At the time a subscriber decides to subscribe to an application, the subscriber is shown details relating to price, message frequency, and maximum messages in any given time period and other terms relating to the specific application. Upon agreeing to those terms and conditions, those terms and conditions are memorialized for that specific subscriber within the online community, such that if the application provider later changes the price or other terms of the service, such new terms will only apply to the new subscribers that enter a “contract” after the date of change. The system ensures enforcement of the original terms and conditions that each individual subscriber was shown and agreed to.

In step 1602, the global mobile platform 304 receives via its interface 1402 a message to send to a user. As part of the agreed upon API, the message arrives from an identifiable source and specifies the recipients for the message. A recipient can be a single user or it could be a group such as “San Diego Padre fans,” which the system will expand into the individual subscribers when delivering the message.

Thus, in step 1604, the global mobile platform analyzes historical information about messages sent by this sender to the specified recipient. In step 1606, this historical data can be compared to the pre-defined limits for the message sender. If the message would cause the pre-determined limits to be exceeded, then the message is discarded in step 1610 thereby avoiding billing of the user. If the message is allowable, then the message is sent as normal in step 1608.

In the above description of the various aspects, the specific example of a software application provider was described in detail. This specific example was provided merely to highlight many of the features and aspects of the embodiments described herein, but one of ordinary skill will recognize that providers of other types of products and services may also utilize and benefit from the mobile community system of FIG. 2. In particular, certain embodiments can allow vendors of all types of products and/or services to charge for their products via the mobile community's existing connectivity to the various carrier systems. In practice, a purchaser would consummate a transaction with a vendor for some product or service and, in the process, provide to the vendor a means of identifying that user within the mobile community. The vendor, in turn, will communicate with the mobile community (e.g., via the Mobile Global Platform) to initiate a billing event that identifies the purchaser and the transaction amount. As explained above, this billing event will result in the purchaser being billed via their wireless telephone subscriber account. In this way, the wireless telephone account (although this information is not necessarily revealed to the vendor) acts as a virtual wallet allowing the purchaser to easily pay for a variety of different types of transactions.

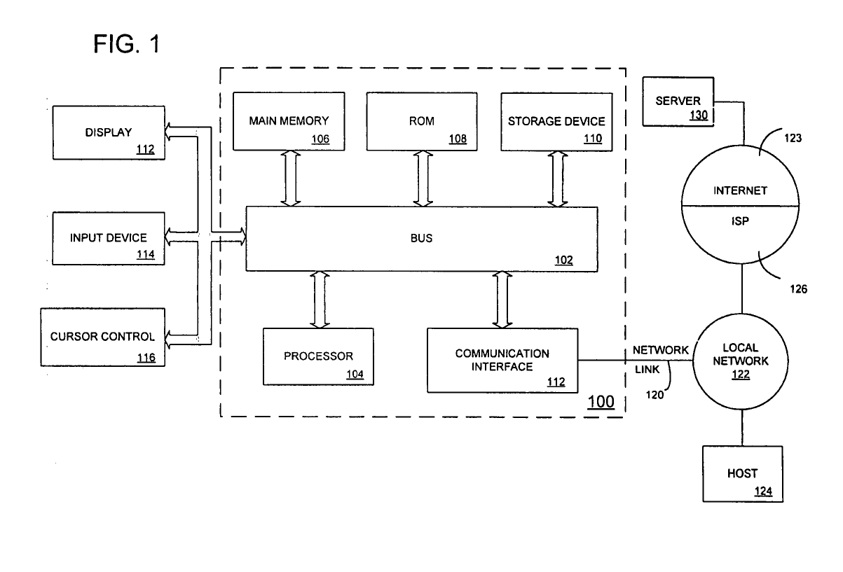

At least portions of the invention are intended to be implemented on or over a network such as the Internet. An example of such a network is described in FIG. 1. The description of the network and computer-based platforms that follows is exemplary. However, it should be clearly understood that the embodiments describe herein may be practiced without the specific details described herein. Well known structures and devices are shown in block diagram form in order to avoid unnecessarily obscuring the discussion.

FIG. 1 is a block diagram that illustrates a computer system 100 upon which an embodiment of the invention may be implemented. Computer system 100 includes a bus 102 or other communication mechanism for communicating information, and a processor 104 coupled with bus 102 for processing information. Computer system 100 also includes a main memory 106, such as a random access memory (RAM) or other dynamic storage device, coupled to bus 102 for storing information and instructions to be executed by processor 104. Main memory 106 also may be used for storing temporary variables or other intermediate information during execution of instructions to be executed by processor 104. Computer system 100 further includes a read only memory (ROM) 108 or other static storage device coupled to bus 102 for storing static information and instructions for processor 104. A storage device 110, such as a magnetic disk or optical disk, is provided and coupled to bus 102 for storing information and instructions.

Computer system 100 may be coupled via bus 102 to a display 112, such as a cathode ray tube (CRT), for displaying information to a computer user. An input device 114, including alphanumeric and other keys, is coupled to bus 102 for communicating information and command selections to processor 104. Another type of user input device is cursor control 116, such as a mouse, a trackball, or cursor direction keys for communicating direction information and command selections to processor 104 and for controlling cursor movement on display 112. This input device typically has two degrees of freedom in two axes, a first axis (e.g., x) and a second axis (e.g., y), that allows the device to specify positions in a plane.

Computer system 100 operates in response to processor 104 executing one or more sequences of one or more instructions contained in main memory 106. Such instructions may be read into main memory 106 from another computer-readable medium, such as storage device 110. Execution of the sequences of instructions contained in main memory 106 causes processor 104 to perform the process steps described herein. In alternative embodiments, hard-wired circuitry may be used in place of or in combination with software instructions to implement the invention. Thus, embodiments of the invention are not limited to any specific combination of hardware circuitry and software.

The term “computer-readable medium” as used herein refers to any medium that participates in providing instructions to processor 104 for execution. Such a medium may take many forms, including but not limited to, non-volatile media, volatile media, and transmission media. Non-volatile media includes, for example, optical or magnetic disks, such as storage device 110. Volatile media includes dynamic memory, such as main memory 106. Transmission media includes coaxial cables, copper wire and fiber optics, including the wires that comprise bus 102. Transmission media can also take the form of acoustic or light waves, such as those generated during radio-wave and infra-red data communications.

Common forms of computer-readable media include, for example, a floppy disk, a flexible disk, hard disk, magnetic tape, or any other magnetic medium, a CD-ROM, any other optical medium, punch cards, paper tape, any other physical medium with patterns of holes, a RAM, a PROM, and EPROM, a FLASH-EPROM, any other memory chip or cartridge, a carrier wave as described hereinafter, or any other medium from which a computer can read.

Various forms of computer readable media may be involved in carrying one or more sequences of one or more instructions to processor 104 for execution. For example, the instructions may initially be carried on a magnetic disk of a remote computer. The remote computer can load the instructions into its dynamic memory and send the instructions over a telephone line using a modem. A modem local to computer system 100 can receive the data on the telephone line and use an infra-red transmitter to convert the data to an infra-red signal. An infra-red detector can receive the data carried in the infra-red signal and appropriate circuitry can place the data on bus 102. Bus 102 carries the data to main memory 106, from which processor 104 retrieves and executes the instructions. The instructions received by main memory 106 may optionally be stored on storage device 110 either before or after execution by processor 104.

Computer system 100 also includes a communication interface 118 coupled to bus 102. Communication interface 118 provides a two-way data communication coupling to a network link 120 that is connected to a local network 122. For example, communication interface 118 may be an integrated services digital network (ISDN) card or a modem to provide a data communication connection to a corresponding type of telephone line. As another example, communication interface 118 may be a local area network (LAN) card to provide a data communication connection to a compatible LAN. Wireless links may also be implemented. In any such implementation, communication interface 118 sends and receives electrical, electromagnetic or optical signals that carry digital data streams representing various types of information.

Network link 120 typically provides data communication through one or more networks to other data devices. For example, network link 120 may provide a connection through local network 122 to a host computer 124 or to data equipment operated by an Internet Service Provider (ISP) 126. ISP 126 in turn provides data communication services through the world wide packet data communication network now commonly referred to as the “Internet” 128. Local network 122 and Internet 128 both use electrical, electromagnetic or optical signals that carry digital data streams. The signals through the various networks and the signals on network link 120 and through communication interface 118, which carry the digital data to and from computer system 100, are exemplary forms of carrier waves transporting the information.

Computer system 100 can send messages and receive data, including program code, through the network(s), network link 120 and communication interface 118. In the Internet example, a server 130 might transmit a requested code for an application program through Internet 128, ISP 126, local network 122 and communication interface 118. The received code may be executed by processor 104 as it is received, and/or stored in storage device 110, or other non-volatile storage for later execution. In this manner, computer system 100 may obtain application code in the form of a carrier wave.

As mentioned, a developer can create and develop a pod application in a number of different ways using any of a variety of different development languages and environments. While different pod applications may accomplish many different purposes, there are certain functions that many pods will have in common. For example, sending an e-mail message or a text message to a recipient may be a common function shared among diverse pod applications. Also, building a query string for a database or forwarding a media file to a rendering engine are some functions that many different pod applications will likely include as well. Thus, the availability of libraries of re-usable code may advantageously be provided within one or more implementations of the system described herein. For example, referring to FIG. 3, a set of libraries 301 is provided to developers who log into the pod application development system. The developer may locate within the libraries of code 301 (in any one of many different languages) one or more previously developed functions or code-segments which pertain to a pod application the developer is designing. Once located, these code segments can then be downloaded by the developer and used, and re-used, in the development of pod applications. In one embodiment, the developer libraries 301 may also allow developers to upload their own code to further widen the variety of available libraries for downloading by other developers. Appropriate security and code checking would likely be implemented to ensure unsafe or malicious code was not uploaded to the developer libraries 301.

In FIG. 3, the developer libraries 301 are shown as a logical block available through the Global Mobile Platform 306. This depiction is exemplary in nature and one of ordinary skill will recognize that the libraries 301 may be provided in a variety of different storage formats, computer platforms, and interconnected systems without departing from the intended scope.

Using the developer's own resources as well as the available developer libraries 301, a developer can design various pods such as a pod to share music and/or alert users about the availability of new music. In addition to music, other media files such as video, text data, pictures and other digital content may be shared through developer-created application pods as well.

In other embodiments, the aforementioned platform provides support tools, functions and services to allow developers to easily develop application pods that are dynamic and community-based for access and use by mobile phone users to provide information, content and/or services to mobile phone users and billed on a micro-transaction level through the platform. The support tools, functions and services enable the application pods to provide the user with consistent community functions and to communicate data to and from the application pod in a dynamic fashion.

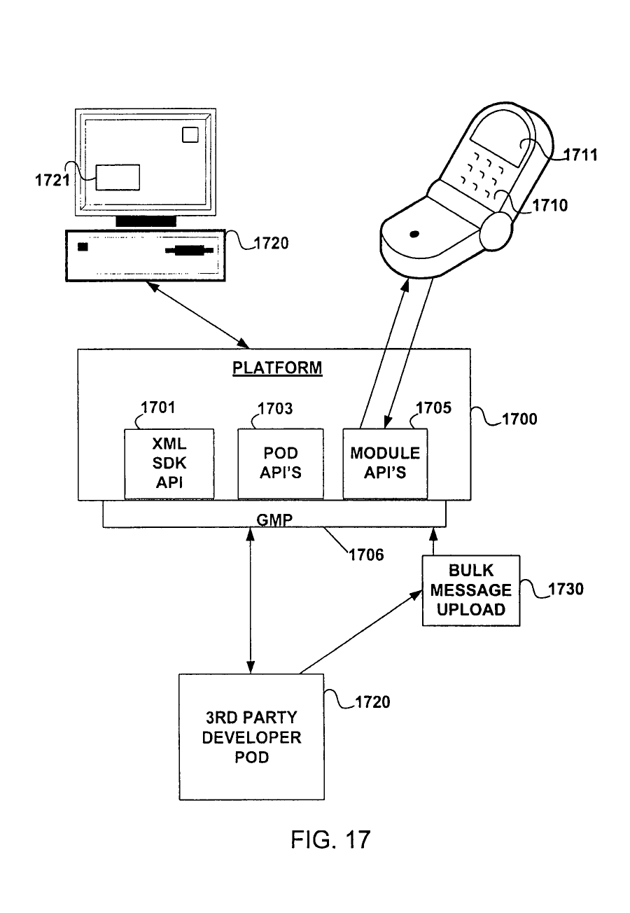

In this regard, FIG. 17 depicts an exemplary embodiment of the above-described community platform. As seen in FIG. 17, mobile community platform 1700 is provided which is described above as mobile community 202 of FIG. 2, and includes the components described above with respect to FIG. 3. In the embodiment shown in FIG. 17, mobile community platform 1700 includes several sets of APIs that are used by a third party developer to develop an application pod and also that are used by platform 1700 to provide community-based dynamic functionality to application pods thereby allowing users of such application pods to benefit from the community services and functions available through community platform 1700.

In particular, community platform 1700 is seen to include xPML software development kit (SDK) APIs 1701, Pod APIs 1703 and Mobile APIs 1705. In the example of FIG. 17, xPML SDK APIs 1701 and Pod APIs 1703 are preferably made available to third-party developers through global mobile platform 1706 (same as described of above with respect to FIG. 3) of community platform 1700. Mobile APIs 1705 are used by community platform 1700 to convert an application pod's functionality for display and use of the application pod on a mobile device, such as a mobile phone 1710, instead of on a personal computer, such as computer 1721. In FIG. 17, third party application pod 1720 is developed by a third party incorporating some or all of the functional interface, functions and services provided by xPML SDK APIs 1701 and Pod APIs 1703, and offers the developed application pod 1720 through community platform 1700 to users of community platform 1700. Community platform 1700 then renders the pod 1721 in HTML according to the APIs implemented in application pod 1720 for access and use on computer 1720, or, if mobile phone 1710 is being used to access application pod, then it is rendered in a mobile protocol, such as WAP or other suitable protocol, for display 1711 on mobile phone 1710.

xPML SDK APIs 1701 are provided by platform 1700 to third party developers to implement into an application pod in order to take advantage of community services and functions offered by platform 1700. Among other functions and services, xPML SDK APIs 1701 provide function “tags” that a third-party developer can incorporate in an application pod to add community functionality and efficient communication to the application pod.

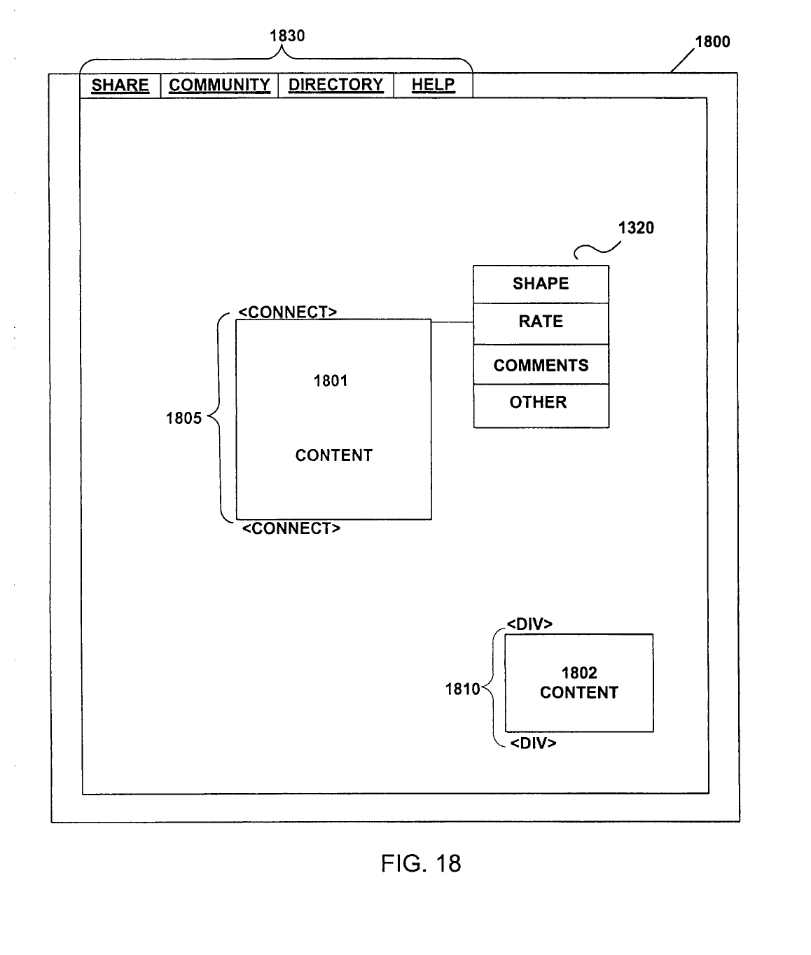

FIG. 18 is a depiction of an application pod that was developed using tags provided by xPML SDK APIs 1701. As seen in FIG. 18, the use of certain tags within an application pod is graphically demonstrated for explanatory purposes. Application pod 1800 is shown in FIG. 18, in which the third-party developer has configured content area 1801 and content area 1802 within the frame of pod 1800 for displaying desired content. For example, content area 1801 may be a picture, and content area 1802 may be dynamic text that contains comments related to the picture in content area 1801. As further seen in FIG. 18, the third party developer has incorporated tags 1805 that bracket content area 1801, and also tags 1810 that bracket content area 1802. In this example, both of tags 1805 and tags 1810 are provided by xPML SDK APIs 1701.

Tags 1805 are <content> tags that allow a user of application pod 1800 to use community-based functions with respect to the content that is bracketed between <content> tags 1805. In this regard, when a user scrolls the mouse or pointing device over content area 1801, the content tags 1805 trigger the display of a pop-up side menu 1820 which contains several community-based menu functions. Menu 1820 allows a user of pod 1800 to share the content of content area 1801 with other users of the community platform, to rate the content of content area 1801 for other users of pod 1800 to see, to enter comments regarding the content of content area 1801 for other users of pod 1800 to see, or other community-based functions, such as receiving information about more application pods that are popular with other users of this pod, and such as obtaining help information related to this pod. In this manner, a third party developer can easily incorporate and take advantage of the community-based functionality and services supported by the community platform simply by incorporating the <content> tags provided by xPML SDK APIs 1701.

Also seen in FIG. 18, the tags 1810 that bracket content area 1802 are <div> tags. These <div> tags allow the content in content area 1802 in between the <div> tags to be refreshed without having to refresh the entire display of pod 1800. In this manner, only some displayed content on pod 1800 can be refreshed and updated, without needing the time, bandwidth and computing resources necessary to update the entire pod display. For example, the targeted content area may contain a static picture, and content area 1802 may contain a text display of the most recent comment related to the picture entered by all users of pod 1800. When a new comment is entered by one of the users of pod 1800, then only content area 1802 is updated to display the new content because of the use of the <div> tags around content area 1802. This is more efficient than having to re-render the entire display of pod 1800. This targeting method can be used with any other HTML element, not just <div> tags.

Of course, many other functions and services are supported by tags provided by xPML SDK APIs 1701. In addition to the <content> and <div> tags, tags provided by xPML SDK APIs 1701 also includes tags for incorporating predetermined menus into the pod, and for allowing a developer to set up a user dictionary related to the pod in order to request information about certain items subjects related to the pod.

Returning to FIG. 17, Pod APIs 1703 provide functions and services for the third party developer to incorporate into application pod 1800 to easily render the graphic interface of the frame (as opposed to the content window) of application pod 1800, and also to incorporate a standard set of menus into the pod frame, such as long the upper tool bar area of the pod frame. In this manner, the pods developed for use with platform 1700 will all have a consistent look and feel to them, and also will have a same basic set of standard menus for operation of the pod and for access and use of community services.

In this regard, when a third party developer develops an application pod that incorporates APIs from Pod APIs 1703, a pod frame will be rendered for display to a user of the pod in a predetermined fashion, and will also incorporate a standard set of functional menus in the upper toolbar of the pod frame. Pod 1800 of FIG. 18 demonstrates a pod frame that is rendered according to a predetermined API that the developer of pod 1800 simply incorporated into application pod 1800. In addition, the upper toolbar 1830 of pod 1800 was implemented by the third party developer of pod 1800 simply by incorporating an API from Pod APIs 1703. As seen in FIG. 18, upper toolbar 1830 includes functional menus for “Share,” “Community,” “Directory” and “Help.” For example, the “Share” menu of upper toolbar 1830 allows the user of pod 1800 to send a message to other users recommending this application pod to them. The message can be sent by SMS, IM, email, or other means.

The “Community” menu of upper toolbar 1830 allows the user of pod 1800 to rate application pod 1800, such as by a range of 1 to 5 stars, or to comment on application pod 1800 for other users of application pod 1800 to view, or to access a blog related to application pod 1800. The “Directory” menu of upper toolbar 1830 displays a list of other application pods that are recommended by other users of this application pod, and the “Help” menu of upper toolbar 1830 allows the user to access help related to application pod 1800, such as by contacting the developer/operator of pod 1800 for assistance. In this manner, many different types of application pods can be provided to the community, while still maintaining a same look and feel, and basic community functionality among all of the application pods.

Returning back to FIG. 17, Mobile APIs 1705 is seen provided in platform 1700, and provides a set of interfaces to allow an application pod, and a user's home page, to be displayed on a mobile device, such as mobile phone 1710. In this regard, the community platform recognizes when a user is requesting to access an application pod from a computing device, such as computer 1720, or from a mobile device, such as mobile phone 1710. Platform 1700 then renders application pod 1720 appropriately, such as in HTML 1721, if the pod is being accessed from computer 1720, or in WAP by using Mobile APIs 1705, if the pod is being accessed from mobile phone 1710. The detection of the type of device accessing the application pod, and the appropriate rendering based on that detection is discussed above with respect to FIG. 13.

Platform 1700 can also pass the detection of the type of device accessing the pod to application pod 1800, so that the developer can include logic to change the functionality of application pod depending on the type of device that is accessing the pod. Also as seen in FIG. 17, Mobile APIs 1705 supports two-way communication between platform 1700 and application pod 1711 on mobile phone 1710. In this manner, the user of an application pod on mobile phone 1710 can have two-way communication via the application pod, such as to receive and reply to messages from the developer/operator of the application pod. Also, the user of application pod 1800 can enter commands to application pod 1720 via mobile phone 1710 and then receive responses in application pod 1800 from platform 1700 or from the developer/operator of pod 1700. For example, if application pod 1800 is a stock price reporting service, then the user can enter a new requested stock name via mobile phone 1710, and a message is sent from mobile phone 1710 to platform 1700 and on to the developer/operator 1720 to obtain the requested stock price, which is then sent back to mobile phone 1720 via platform 1700. In this manner, application pods that incorporate the functionality of Mobile APIs 1705 provide dynamic communication and functionality to the user on a mobile device. The communication between mobile phone 1710, platform 1700 and the developer/operator can be in SMS, MMS, email or other communication means.

In this regard, Mobile APIs 1705 also provides the functionality for the third party developer/operator of an application pod to easily send communications to users of the application pod. In particular, the developer/operator can address messages to be sent to all users of the application pod, or to specific users as addresses by a user ID. In this manner, users of the application pod can receive new content through the application pod on a periodic basis, or can receive information messages from the developer/operator regarding the application pod. Mobile APIs 1705 also provides a developer/operator with the functionality to schedule a block of various messages to be sent to various users of the application pod for a predetermined duration of time.

For example, if the developer/operator can schedule all messages that need to be sent to all users and to only some specified users, over the course of the next three months. This feature greatly assists the developer/operator in getting data and information sent to users of the application pod for a long period of time. This “bulk” scheduling of messages to users of application pod 1720 is shown in FIG. 17, in which the developer/operator uploads to platform 1700 a bulk schedule 1730 of many messages to be sent to various groups of users of application pod 1720. The messages in bulk schedule 1730 are then delivered by platform 1700 to users according to the appropriate date/time and appropriate user IDs to which each message is addressed.

In certain embodiments, mobile community platform 202 can be configured to act as a messaging service that allows the users fop platform 202 to communicate using Instant Messaging (IM) type messaging. In certain embodiments, platform 202 can provide a default IM service that can be used by the users of platform 202. In other embodiments, a user can specify a desire to use a third party IM service. In such instances, platform 202 can use information supplied by the user it port information related to the third party IM service into platform 202 so that the user can view the status of their third party M service, e.g., buddy lists, presence information, etc., and can send and receive messages using the third party IM service. In certain embodiments, the platform can be configured to use the default IM service provided by platform 202 and to translate incoming and outgoing messages between this service and the third part service.

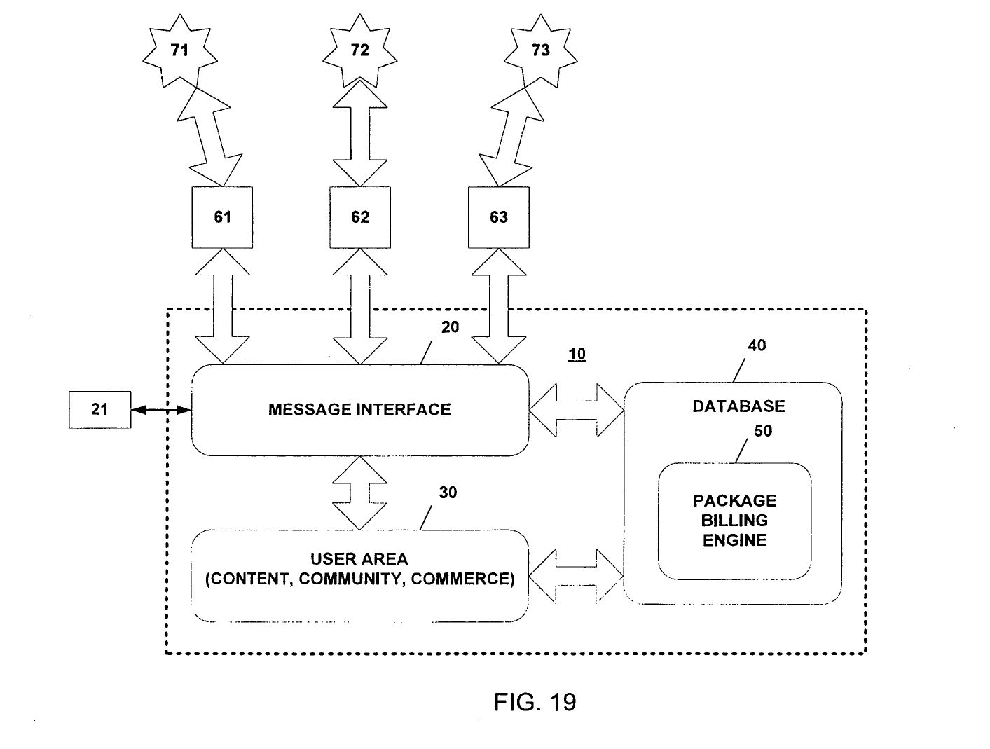

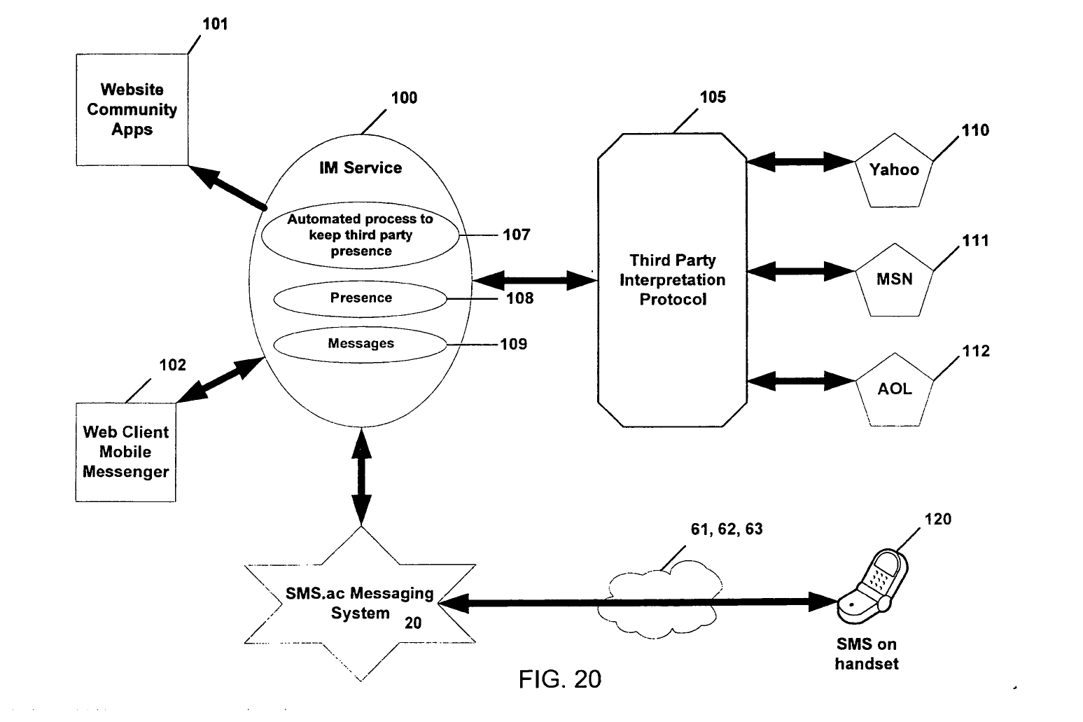

FIGS. 19-20 are diagrams illustrating how default and third party IM services can be made available to users of platform 202. It will be understood that IM is just one example of a type of messaging service that can be provided through platform 202 and that other default and third party services can be made available.

FIG. 19 depicts a block diagram of a computer-based mobile community platform 10 in accordance with another embodiment. Users (such as user 21) can connect to the mobile community platform 10 via a network or similar communications channel. As noted above, the user can create a profile page or “home page” that they can personalize. This profile page can include various files and content that the user wants to share with other members of the mobile community platform 10.

Additionally, the mobile community platform 10 can be configured to connect with various cellular carrier systems 61, 62, 63, each of which has an associated community of mobile phone subscribers, 71, 72, 73. Users (such as user 21) of the mobile community platform 10 can also be subscribers of the various cellular carriers. Users of the mobile community platform 10 can not only have access through the computer-based platform 10 to other users' profile pages, they can also have easy access to subscribers of the various cellular carrier systems 61, 62, 63.

As seen in FIG. 19, some of the sub-components of the mobile community platform 10 are a message interface 20 (described above), user area 30 where the content, community and commerce functions are accessed by and handled for the users (also described above), and a database 40 with package billing engine 50 implemented therein. The details of these different sub-components, with respect to the embodiment being currently described, are more fully explained throughout the remainder of this detailed description.

As noted earlier, users, such as user 21, can visit the user area 30 to participate in an on-line community that includes various content and commerce opportunities. This is typically accomplished via a user's web browser that may be hosted on a laptop or desktop computer, or in the alternative, even on the user's mobile device such as a PDA or mobile phone. Thus, the user area 30 can include a web server that communicates with users and interfaces with database 40 which includes a data store of user information and other content. With these resources, the mobile community platform 10 can present to a user a profile page (“home page”) that reflects content and information associated with, and desired by, that particular user. This content and information is not maintained on the local computer being used by the user but, rather, is maintained and managed by the computer systems within mobile community platform 10.

Although not explicitly depicted in FIG. 19, one of ordinary skill will recognize that there are numerous functionally equivalent techniques to create, manage, store and serve user information, user profiles, user content, software tools and other resources within the user area 30. Included in these techniques are methods to ensure security, data integrity, data availability and quality of service metrics.

The message interface unit 20 includes applications for connecting with and communicating with the multiple different cellular carriers 61, 62, 63 that have been partnered with the platform of mobile community 10. The message interface unit 20 can be configured to generate message requests in the appropriate format for each of the cellular carriers 61, 62, 63 including tariff information that determines the amount for which the recipient of the message will be charged. Upon receipt of the message request, the cellular carriers 61, 62, 63 will use information in the request, e.g. a “short code,” to generate an appropriate message to the intended recipient/subscriber of the cellular carrier and then bill the recipient/subscriber's cellular service account for the specified amount.

The message interface unit 20 can be configured to communicate with the user area 30, such that users of the mobile community 10 can advantageously use the connectivity of the message interface unit 20 with the carriers in order to send messages to subscribers of any of the cellular carriers 61, 62 63. The messages may be text messages, such as SMS messages, MMS messages, email messages, or other message formats that are subsequently developed. Some of these messages may have zero tariff and, therefore do not generate a bill (other than the underlying charges implemented by the cellular carrier) and others may have non-zero tariffs resulting in a billing event for the recipient.

As mentioned above, database 40 includes information corresponding to each user of mobile community 10, and can include data corresponding to the services and applications requested by that user, and also includes a message credit balance that corresponds to number of remaining standard messages that are allowed to the user according to the predefined package of premium messages and standard messages that the user has requested.

FIG. 20 is a block diagram illustrating an exemplary embodiment of an interoperable message service in accordance with one embodiment, and its interrelationship with the mobile community platform 10, and with third-party message services 110, 111 and 112. As seen in FIG. 20, interoperable instant message service 100 can be connected with messaging system 20 of mobile community platform 10 to send instant messages to/from a user's mobile device, such as mobile phone 120, e.g., through SMS messages via the user's cellular carrier, such as one of the cellular carriers 61, 62 63. Interoperable instant message service 100 can also integrate with website community applications 101, such as those provided by user area 30 shown in FIG. 19. In this manner, users of mobile community platform 10 can access the functionality of interoperable instant message service 100 while using another application or feature provided through website community applications 101 of mobile community platform 10.

Web client mobile messenger 102 can be provided so that a user of mobile community platform 10 can access and use the instant message service provided by interoperable instant message service 100 from a standard computer or from a connected mobile device, such as mobile phone 120. As further seen in FIG. 20, interoperable instant message service 100 interacts with third-party interpretation protocol 105, which can be configured to translate instant messages between the format of third-party message services 110 to 112 and the format of interoperable instant message service 100, and which can act as a communication port between third-party message services 110 to 112 and interoperable instant message service 100. In this manner, the user of interoperable instant message service 100 can use a single format, e.g., a default format provided by interoperable instant message service 100, to send and receive messages from any one of many third-party message services.

In order to achieve this translation between the default service and the third party service, interoperable instant message service 100 can be configured to use an automated process 107 to continuously detect the presence of a user of one of third-party message services 110 to 112, either online by a computer or on a connected mobile phone. The presence 108 of all users can then be maintained and the messages 109 to/from such users can be managed and provided by translating between the default message format and protocol to the appropriate third party format and protocol.

Thus, interoperable instant message service 100 can preferably be the default instant messaging service for mobile community platform 10. In this manner, signed-in users of platform 10 can instantly communicate with one another via a live chat window once they are signed in. Additionally, if the user chooses, the user can receive and reply to instant messages from their mobile phones that originated from the web site of mobile community platform 10.

In certain embodiments, the user can select to receive messages to their phone originated from anyone, from only their friends, from friends they select, or from nobody (prevents anyone from sending instant messages to their phone).

Interoperable instant message service 100 is interoperable with multiple major IM services, such as MSN, AOL, and Yahoo. Thus, users of interoperable instant message service 100 can, in certain embodiments, sign in and view their buddy lists and IM users on third-party message services. Thus, once the user has entered correct information they will be able to view their third party IM lists through platform 10. For example, a mobile messenger list can be maintained and presented to the user via service 100. When the user has indicated a desire to use a third party service 110-112, then service 100 can import the contacts in the user's third party profile. If the user uses more than one third party service 110-122, then the defaulted lists for the user's third part accounts can be consolidated across all third party services 110-112 into a friends list maintained by service 100. The friends list can also include information for friends within platform 10. All offline contacts can also be consolidated across third services 110-112 and platform 10 into an offline folder.

This presence state of the user can be reported by service 100 to the third party services 110-112 and can be shown to all third party users that have the logged in user on their third party client's IM list. Presence service 108 can be configured as an automated process that maintains presence on the third party services 110-112. Third party presence can be shown on the mobile messenger list presented by service 100 to the user, e.g., with the same icons the third party IM client uses.

When the user is online, e.g., connected to platform 10 through the user's computer, then the user can be shown in the third party client as online. Any IM messages sent through the service 100 can then be sent to a third party IM client. In certain embodiments, any emoticons that are sent through this method can be converted to a similar emoticon supported by the third party service.

Any IM messages sent through the third party clients to a user who has set up a third party account on platform 10 can then be received via service 100, e.g., when the receiving user has an online or online(away) presence status with service 100. Service 100 can perform whatever translations are needed between the format and protocols of the third party service and the format and protocols of the service supported as the default service by service 100.

A user of platform 10 can also send and receive instant messages via their mobile phone including third party messages, e.g., messages supported by third party services 110-112. For example, interoperable instant message service 100 can also includes an automated IM redirection service configured to take certain messages the user receives through one of the third-party message services or through service 100 and send them to the user's mobile phone. The redirection service can be configured to use a web client that maintains presence on the third-party message service IM clients so that other third-party message service users will be able to send IM messages to the user's phone.

For example, any IM messages sent through the third party clients to a user who has set up a third party account on platform 10 can be sent to the user's mobile phone when the receiving user has the connected presence status. Thus, redirection service 109 can forward the message to message interface 20 to be forwarded to the user's mobile phone. As describe above, message interface can convert the message to an SMS message, or other appropriate format, in order to forward the message to the user's mobile phone.

When the mobile phone user replies to a third party IM text message, the reply will be routed to the third party client through message interface 20 and service 100 as an IM message to the third party contact user. In this manner, mobile users of platform 10 can still communicate via a third party, or default, M service.

Interoperable instant message service 100 is integrated with other applications provided by mobile community platform 10. Most notably, Presence (the ability to see whether or not users are online, activated and opted into mobile IM, etc) can be built into any area of the user area 30 that Primary Photos are displayed, including MHP's, Friend's Pods, BMF, Flirt and Friends search results, and the Friend Finder on the site homepage. Presence can be visually communicated through the use of icons indicating “online now” for signed-in users via computer, or “connected” via mobile phone for activated users of mobile community platform 10.

Interoperable instant message service 100 can be provided to users in a pop-up window displayed upon sign-in to platform 10 or also pops up by clicking on, e.g., a Mobile Messenger text link in a global navigation header presented by platform 10. A Messenger Window can be presented in the form of a “Buddy List” containing all local friends and any contacts from third-party message service clients. There can be presented phone icons next to each contact to allow users to manage which friends are allowed to send IM messages to that user's mobile phone. A chat interface (Message Window) is triggered by clicking the Messenger Presence icon next to wherever a user's display name appears on the site or by clicking on the name of a Friend within the Messenger List Window.

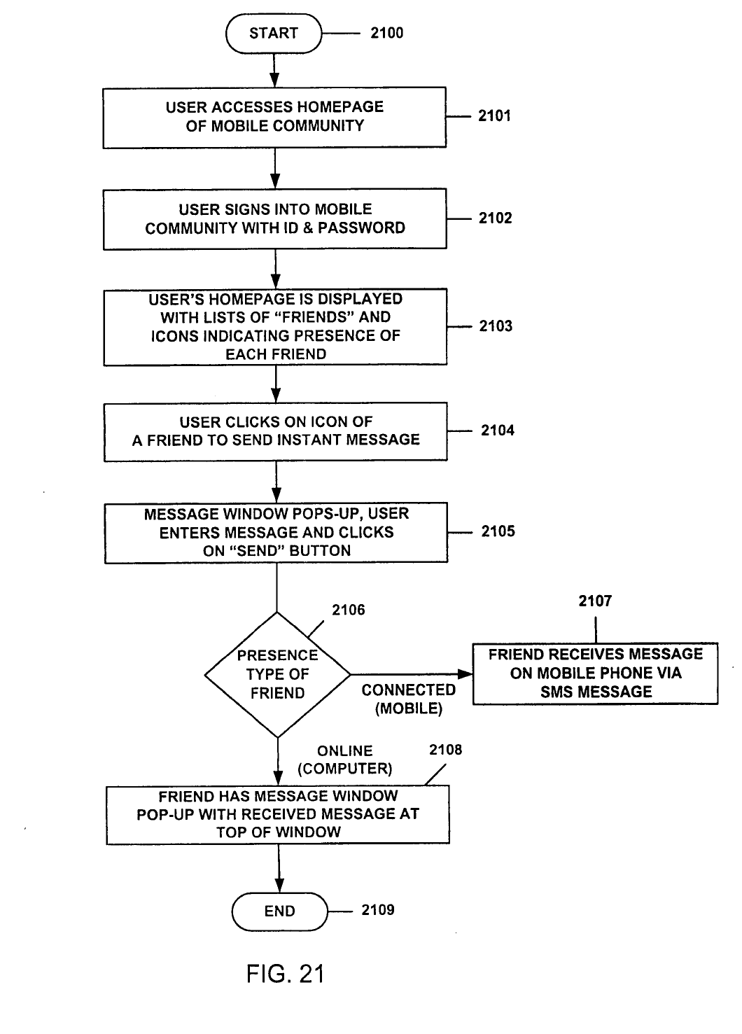

FIG. 21 provides a basic flowchart for describing the elemental function of interoperable instant message service 100 according to one embodiment. As seen in FIG. 21, the process starts at step 2100, and the user accesses the web homepage of the mobile community platform in step 2101. The user then signs into the mobile community via the web homepage by entering the ID and password of the user (step 2102). In step 2103, the user's unique homepage is displayed by the mobile community platform, and the user's homepage includes lists of the user's friends along with corresponding icons next to each friend that uses a message service, where the icon designated the “presence” status of each friend, such as “online” when the friend is on a networked computer, or “connected” when the friend is on a mobile phone.

The user can then click on the icon corresponding to one of the listed friends in order to send an instant message to that friend (step 2104). A message window pops up on the user's homepage in step 2105, and the user then enters the desired message and clicks on the “Send” button of the message window. A determination is made in step 2106 whether the friend that is the intended recipient of the message has a presence of being “online” via the friend's computer, or being “connected” via the friend's mobile phone. If the friend is “connected” via the friend's mobile phone, the interoperable message service sends the message to the friend's mobile phone, e.g., via an SMS message (step 2107), and the process ends at step 2109. If the friend is “online” via the friend's computer, a message window pops up on the friend's computer with the received message displayed at the top of the message window (step 2108), and the process ends at step 2109.

While certain embodiments of the inventions have been described above, it will be understood that the embodiments described are by way of example only. Accordingly, the inventions should not be limited based on the described embodiments. Rather, the scope of the inventions described herein should only be limited in light of the claims that follow when taken in conjunction with the above description and accompanying drawings.

What is claimed is:

1. A platform for supporting interoperable message services with mobile support, the platform comprising a message service configured to provide a default message service, the platform comprising:
a plurality of communication channels to a respective plurality of wireless network carriers, each of the wireless network carriers having a plurality of users;
at least one processor;
at least one interface having access to the internet; and
at least one computer readable medium carrying one or more sequences of instructions for integrating the network-enabled music application with the platform, wherein execution of the one or more sequences of instructions by the one or more processors causes the one or more processors to perform:
a third party account set up step of receiving, in the platform, third party service information from one of the plurality of users related to the user's third party account with a third party message service;
a third party messaging step of receiving, in the platform using the messaging service, a third party service message via the interface or the plurality of communication channels, the third party service message sent in accordance with the default message service;
a third party message recognition step of recognizing, in the platform using the message service, the message is a third party service message; and
a message translation step of translating, in the platform using the message service, the third party service message for deliver via an appropriate third party message service.

2. The platform of claim 1, wherein the user is a mobile user, and wherein the third party messaging step comprises receiving a third party service message from the mobile users mobile device.

3. The platform of claim 2, wherein the third party service message received from the mobile user's mobile device is in a mobile message format, and wherein execution of the one or more sequences of instructions by the one or more processors causes the one or more processors to perform a conversion step of converting, in the platform, the mobile message format of the third party service message for delivery via an appropriate third party message service.

4. The platform of claim 3, wherein the conversion step further comprises converting the mobile message format into a default message format associated with the default message service before performing the message translation step.

5. The platform of claim 1, wherein execution of the one or more sequences of instructions by the one or more processors causes the one or more processors to perform a presence detection step of detecting, in the platform using the message service, the presence of an intended recipient associated with the third party service message.

6. The platform of claim 1, wherein execution of the one or more sequences of instructions by the one or more processors causes the one or more processors to perform a message forwarding step of forwarding, in the platform using the message service, the translated message to a third party message service associated with the third party service message via the interface.

7. The platform of claim 1, wherein the third party account set up further comprises importing contact information associated with the user's third party account from the third party message service via the interface and making the contact information available to the user in the platform.

8. The platform of claim 1, wherein execution of the one or more sequences of instructions by the one or more processors causes the one or more processors to perform:
a third party messaging receiving step of receiving, in the platform using the messaging service, a third party service message intended for the user, the third party service message originating form a third party message service; and
a message translation step of translating, in the platform using the message service, the third party service message for deliver to the user via the default message service.

9. The platform of claim 8, wherein the user is a mobile user interfaced with the platform via a mobile device, and wherein execution of the one or more sequences of instructions by the one or more processors causes the one or more processors to perform a conversion step of converting, in the platform, the third party service message for delivery to the mobile user's mobile device.

10. The platform of claim 9, wherein the conversion step further comprises converting the third party service message into a default message format associated with the default message service before performing the conversion step.

11. A method for supporting interoperable message services with mobile support in a platform comprising a message service configured to provide a default message service, the platform comprising a plurality of communication channels to a respective plurality of wireless network carriers, each of the wireless network carriers having a plurality of users; the method comprising:
a third party account set up step of receiving, at the platform, third party service information from one of the plurality of users related to the user's third party account with a third party message service;
a third party messaging step of receiving, at the platform using the messaging service, a third party service message via the interface or the plurality of communication channels, the third party service message sent in accordance with the default message service;
a third party message recognition step of recognizing, at the platform using the message service, the message is a third party service message; and
a message translation step of translating, at the platform using the message service, the third party service message for deliver via an appropriate third party message service.

12. The method of claim 11, wherein the user is a mobile user, and wherein the third party messaging step comprises receiving a third party service message from the mobile users mobile device.

13. The method of claim 12, wherein the third party service message received from the mobile user's mobile device is in a mobile message format, and wherein the method further comprises a conversion step of converting, at the platform, the mobile message format of the third party service message for delivery via an appropriate third party message service.

14. The method of claim 13, wherein the conversion step further comprises converting the mobile message format into a default message format associated with the default message service before performing the message translation step.

15. The method of claim 11, further comprising a presence detection step of detecting, at the platform using the message service, the presence of an intended recipient associated with the third party service message.

16. The method of claim 11, further comprising a message forwarding step of forwarding, at the platform using the message service, the translated message to a third party message service associated with the third party service message via the interface.

17. The method of claim 11, wherein the third party account set up further comprises importing contact information associated with the user's third party account from the third party message service via the interface and making the contact information available to the user in the platform.

18. The method of claim 11, further comprising:
a third party messaging receiving step of receiving, at the platform using the messaging service, a third party service message intended for the user, the third party service message originating form a third party message service; and
a message translation step of translating, at the platform using the message service, the third party service message for deliver to the user via the default message service.

19. The method of claim 18, wherein the user is a mobile user interfaced with the platform via a mobile device, and wherein the method further comprises a conversion step of converting, at the platform, the third party service message for delivery to the mobile user's mobile device.

20. The method of claim 19, wherein the conversion step further comprises converting the third party service message into a default message format associated with the default message service before performing the conversion step.
